(19) United States
(12) Patent Application Publication
(10) Pub. No.: US 2025/0384635 A1
(43) Pub. Date: Dec. 18, 2025

(54) CREATING PHYSICS-BASED CONTENT

(71) Applicant: Lemon Inc., Grand Cayman (KY)

(72) Inventors: Weston Bell-Geddes, Los Angeles, CA (US); Runze Zhang, Los Angeles, CA (US); Jie Li, Los Angeles, CA (US); Xinhao Song, Los Angeles, CA (US); Yili Zhao, Los Angeles, CA (US); Zhili Chen, Los Angeles, CA (US)

(21) Appl. No.: 18/744,001

(22) Filed: Jun. 14, 2024

(51) Int. Cl. G06T 19/00

(52) U.S. Cl. CPC G06T 19/006; G06T 2200/24; G06T 2210/21

(57) ABSTRACT

The present disclosure describes techniques for creating physics-based content. A set of physics controller nodes is established. The set of physics controller nodes are configured to refine physics simulations in a three-dimensional (3D) environment. User interfaces configured to implement visual scripting based on the set of physics controller nodes are presented. The physics simulations are customized and optimized utilizing the set of physics controller nodes based on user input received via the user interfaces. Content is created based on the customized and optimized physics simulations.

### BACKGROUND

Communication is increasingly being conducted using Internet-based tools. The Internet-based tools may be any software or platform. Users may create content and design features via such Internet-based tools. Improved techniques for content creation and feature design via such tools are desirable.

### BRIEF DESCRIPTION OF THE DRAWINGS

The following detailed description may be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 shows an example system for creating physics-based content in accordance with the present disclosure.

FIG. 2 shows an example user interface for creating physics-based content in accordance with the present disclosure.

FIG. 3 shows an example user interface for creating physics-based content in accordance with the present disclosure.

FIG. 4 shows an example user interface for creating physics-based content in accordance with the present disclosure.

FIG. 5 shows an example user interface for creating physics-based content in accordance with the present disclosure.

FIG. 6 shows an example user interface for creating physics-based content in accordance with the present disclosure.

FIG. 7 shows an example user interface for creating physics-based content in accordance with the present disclosure.

FIG. 8 shows an example user interface for creating physics-based content in accordance with the present disclosure.

FIG. 9 shows an example user interface for creating physics-based content in accordance with the present disclosure.

FIG. 10 shows an example user interface for creating physics-based content in accordance with the present disclosure.

FIG. 11 shows an example user interface for creating physics-based content in accordance with the present disclosure.

FIG. 12 shows an example user interface for creating physics-based content in accordance with the present disclosure.

FIG. 13 shows an example user interface for creating physics-based content in accordance with the present disclosure.

FIG. 14 shows an example process for creating physics-based content in accordance with the present disclosure.

FIG. 15 shows an example process for creating physics-based content in accordance with the present disclosure.

FIG. 16 shows an example process for creating physics-based content in accordance with the present disclosure.

FIG. 17 shows an example process for creating physics-based content in accordance with the present disclosure.

FIG. 18 shows an example process for creating physics-based content in accordance with the present disclosure.

FIG. 19 shows an example process for creating physics-based content in accordance with the present disclosure.

FIG. 20 shows an example process for creating physics-based content in accordance with the present disclosure.

FIG. 21 shows an example process for creating physics-based content in accordance with the present disclosure.

FIG. 22 shows an example process for creating physics-based content in accordance with the present disclosure.

FIG. 23 shows an example process for creating physics-based content in accordance with the present disclosure.

FIG. 24 shows an example computing device which may be used to perform any of the techniques disclosed herein.

### DETAILED DESCRIPTION OF ILLUSTRATIVE EMBODIMENTS

Current augmented reality (AR) platforms utilize physics systems to a varying degree, with basic functionality for simulating real-world physics in three-dimensional (3D) environments. Traditionally, developers have relied on physics engines and scripting languages to integrate realistic physics simulations into AR content. These engines enable the simulation of basic physics functionalities, such as collision detection, force application, and motion simulation.

However, these existing tools and systems for integrating realistic physics simulations into AR content demand a substantial programming effort and a deep understanding of both physics and software development, which can be barriers to entry for designers with limited coding expertise. For example, implementing complex dynamic physics behaviors, such as acceleration, collision detection, and force application, requires extensive programming knowledge, thereby limiting the ability of creators to bring their visions to life.

While existing tools and systems may offer simplified physics manipulation through pre-defined behaviors, these approaches often lack the flexibility and depth required to create complex and dynamically interactive AR experiences. Existing tools and systems typically provide a generic set of functionalities, with little room for customization or optimization tailored to the specific needs of AR applications. Current tools and systems do not offer the depth of control and customization needed to fine-tune physics simulations for varied and specific AR scenarios, restricting creative freedom and the potential for innovation. This lack of intuitive and accessible tools for physics manipulation in AR development environments leads to inefficient prolonged development cycles, making it challenging to prototype, test, and iterate AR experiences rapidly.

These challenges highlight the need for improved techniques for creating physics-based content. In particular, these challenges highlight the need for an advanced, yet user-friendly, system that empowers creators to intuitively design and implement physics-based interactions within AR environments. Described herein are improved techniques for creating physics-based content. The improved techniques describe herein introduce an advanced physics controller node system integrated into a visual scripting library. The improved techniques described in the present disclosure significantly enhance the development process, improve the quality of AR experiences, and expand the creative possibilities available to physics-based content creators.

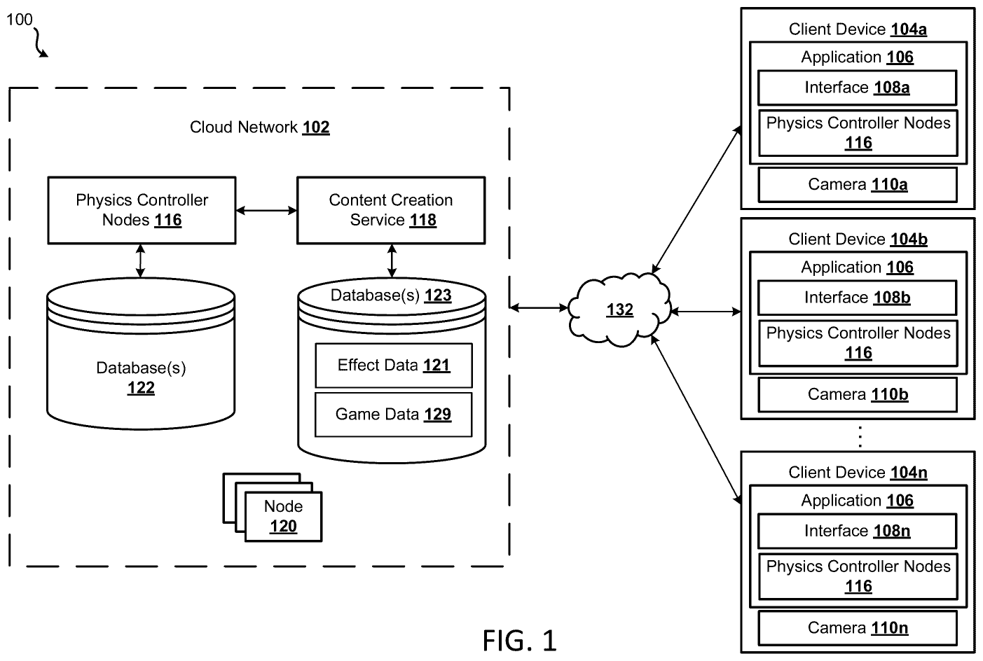

FIG. 1 shows an example system 100 for creating physics-based content, such as interactive effects or games. The system 100 can include a cloud network 102 and a plurality of client devices 104a-n (collectively, 104). The cloud network 102 and the plurality of client devices 104a-n can communicate with each other via one or more networks 132.

The cloud network 102 may be located at a data center, such as a single premise, or be distributed throughout different geographic locations (e.g., at several premises). The cloud network 102 may provide services, such as a content creation service 118, via the one or more networks 132. The network 132 comprise a variety of network devices, such as routers, switches, multiplexers, hubs, modems, bridges, repeaters, firewalls, proxy devices, and/or the like. The network 132 may comprise physical links, such as coaxial cable links, twisted pair cable links, fiber optic links, a combination thereof, and/or the like. The network 132 may comprise wireless links, such as cellular links, satellite links, Wi-Fi links and/or the like.

The cloud network 102 may comprise a plurality of computing nodes 120 that host a variety of services. In an embodiment, the nodes 120 host the content creation service 118. The content creation service 118 may be configured to facilitate the creation/design of content, such as effects and/or games, by a creator or designer (e.g., user, developer) associated with a client device of the plurality of client devices 104a-n. For example, the plurality of client devices 104a-n may each be associated with content creator(s) or designers that want to create or design content. The plurality of client devices 104a-n may comprise an application 106. In some embodiments, the application 106 may comprise a set of physics controller nodes 116. The set of physics controller nodes 116 can be stored, for example, in a database 122. In other embodiments, the set of physics controller nodes 116 may be utilized by the content creation service 118. The set of physics controller nodes will be described in detail below. The application 106 may be used by the creator(s)/designer(s) to create/design content. For example, the creator(s)/designer(s) can access interface(s) 108a-n (collectively, 108) of the application 106 to create/design content.

The plurality of client devices 104a-n may comprise any type of computing device, such as a mobile device, a tablet device, laptop, a desktop computer, a smart television or other smart device (e.g., smart watch, smart speaker, smart glasses, smart helmet), a gaming device, a set top box, digital streaming device, robot, and/or the like. A single user may use one or more of the plurality of client devices 104a-n to access the cloud network 102. The plurality of client devices 104a-n may travel to a variety of locations and use different networks to access the cloud network 102.

The content creation service 118 and/or the application 106 can establish the set of physics controller nodes 116. The set of physics controller nodes 116 can facilitate the creation of content, such as effects and/or games, by a creator (e.g., user, designer, developer) associated with one of the plurality of client devices 104a-n. The set of physics controller nodes 116 can enable the content creation service 118 and/or the application 106 to refine physics simulations in a 3D environment.

The set of physics controller nodes 116 can include an acceleration controller node. The acceleration controller node be used to manage the acceleration of objects, enabling dynamic changes in the speed and direction. The set of physics controller nodes 116 can further include an impulse node. The impulse node can be used to apply instantaneous force to objects, simulating realistic impacts and movements. The set of physics controller nodes 116 can further include a force controller node. The force controller node can be used to cause continuous application of force to objects, enabling sustained movements or interactions. The set of physics controller nodes 116 can further include a velocity controller node. The velocity controller node can be used to directly control the velocity of objects, facilitating precise movements and behaviors. The set of physics controller nodes 116 can further include a physics information node. The physics information node can be used to gathers and display real-time physics properties of objects, such as velocity and mass, aiding in debugging and development during the content creation process.

The set of physics controller nodes 116 can further include a collision event node. The collision event node can be used to detect collisions between objects, triggering specific responses or behaviors. The set of physics controller nodes 116 can further include a collision information node. The collision information node can be used to provides detailed information, such as real-time information, about collision events, including the objects involved in the collision and points of impact associated with the collision. The set of physics controller nodes 116 can further include a ray cast node. The ray cast node can be used to project an invisible ray in the 3D environment to detect objects in the path of the invisible ray. The ray cast node can be useful for line-of-sight interactions and/or distance measurements. The set of physics controller nodes 116 can further include a ray hit information node. The ray hit information node can be used to capture and relay information about objects hit by a ray cast, including distance and hit location.

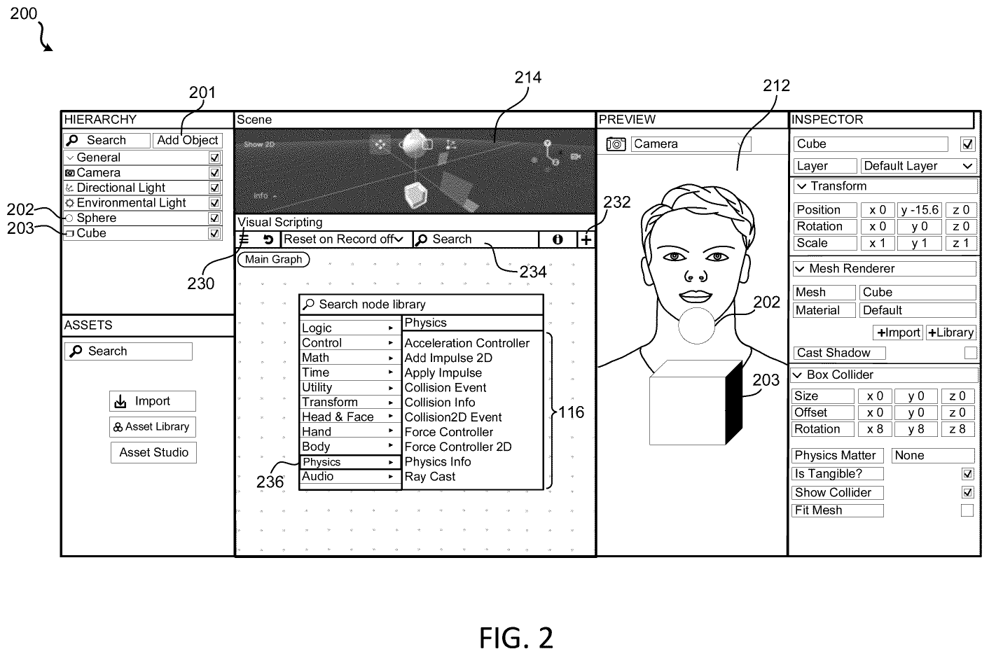

The content creation service 118 and/or the application 106 can cause to present user interfaces (UIs), such as via the client devices 104. The UIs can be configured to implement visual scripting based on the set of physics controller nodes 116. For example, with reference to FIG. 2, the content creation service 118 and/or the application 106 can cause to present the UI 200. The user can view the UI 200.

To begin creating content, a user can add one or more objects to a 3D environment. The UI 200 can present a scene 214 representing the 3D environment. To add the object(s), the user can select a user interface element (e.g., button) 201. The objects can include, for example, a sphere 202 and a cube 203. The UI 200 can comprise a preview window 212. The preview window 212 can display in real time a current design/creation state (e.g., how the content would look if no more changes or modifications are made to the content). The preview window 212 can display the objects and/or interactions between the objects in the 3D environment incorporated with real-time camera inputs.

The user can assign/add components and/or connections/interactions to the objects (e.g., the sphere 202 and/or to the cube 203) in the 3D environment. Components and/or connections from physics tools can be added/assigned to the objects in the 3D environment. The physics tools can include a rigid body, collider components (e.g., a box collider, a sphere collider, a capsule collider), and joint components (e.g., a spring joint, a fixed joint, a hinge joint, a point joint).

The user can customize physical properties of components/interactions comprised in the physics tools. For example, the “rigid body” tool can be utilized to assign a rigid body component to the objects (e.g., the sphere 202 and/or to the cube 203) in the 3D environment. The user can customize the mass and the damping and/or angular damping of the rigid body component. The user can customize the external force and/or the external torque of the object in the 3D environment. The user can indicate whether the user wants the motion of the rigid body component to be frozen (e.g., restricted) along one or more specified axes (e.g., x-axis, y-axis, z-axis), such as to provide stability and control in simulations. The user can specify whether the rigid body component assigned to the object is static (e.g., immovable).

A collider component can be assigned to an object in the 3D environment. The collider component can include a box collider configured to detect and simulate collisions involving box-shaped objects. The collider component can include a sphere collider configured to detect and simulate collisions involving sphere-shaped objects. The collider component can include a capsule collider configured to detect and simulate collisions involving capsule-shaped objects. The user can edit the properties associated with the collider component, such as the radius, the offset, the physics matter, whether the sphere collider component is tangible, whether a collider component (e.g., a sphere collider) should be visible, and/or whether the user wants a mesh to be fit to the sphere collider component. A joint component can enable an attachment between two or more objects in the 3D environment. The user can specify one or more connected bodies (e.g., the other object(s) in the connection), one or more anchor types for the joint component, and/or a breaking force and/or torque force for the joint component.

The preview window 212 can show the user a current design state of the content. The 3D environment can be integrating with real-time user and camera inputs. For example, a feed of a camera (e.g., camera 110a-n) can be combined with the 3D environment. In the example of FIG. 2, the preview window 212 displays the real time feed of the camera (e.g., images or a video of a person) integrated with the 3D environment comprising the objects, thereby implementing seamless AR.

To refine physics simulations in the 3D environment including the objects, the user can add a node from the set of physics controller nodes 116 to a visual scripting window 230. To add a node from the set of physics controller nodes 116 to the visual scripting window 230, the user can select a button 232. Alternatively, to add a node from the set of physics controller nodes 116 to the visual scripting window 230, the user can left click in the visual scripting window 230. If the user selects the button 232 and/or left clicks in the visual scripting window 230, a list of nodes can be presented on the UI 200. The user can select a button 236 from the list of nodes to indicate that the user wants to add a physics controller node to the visual scripting window 230. In response to the user selecting the button 236, a list of the physics controller nodes 116 can be displayed on the UI 200. The user can select a desired physics controller node from the list. Alternatively, to add a node from the set of physics controller nodes 116 to the visual scripting window 230, the user can use a search bar 234 to search for a desired physics controller node.

As the user selects one or more physics controller nodes 116 from the list displayed on the UI 200, the content creation service 118 and/or the application 106 can cause display of the selected nodes on the visual scripting window 230. The user can connect the nodes in the visual scripting window, such that a sequence of interconnected nodes governs the application of physics principles to the objects based on user-defined parameters and refines real-time AR scene interactions. In this manner, the visual scripting window 230 provides a user-friendly interface for visually scripting complex physics interactions within AR environments.

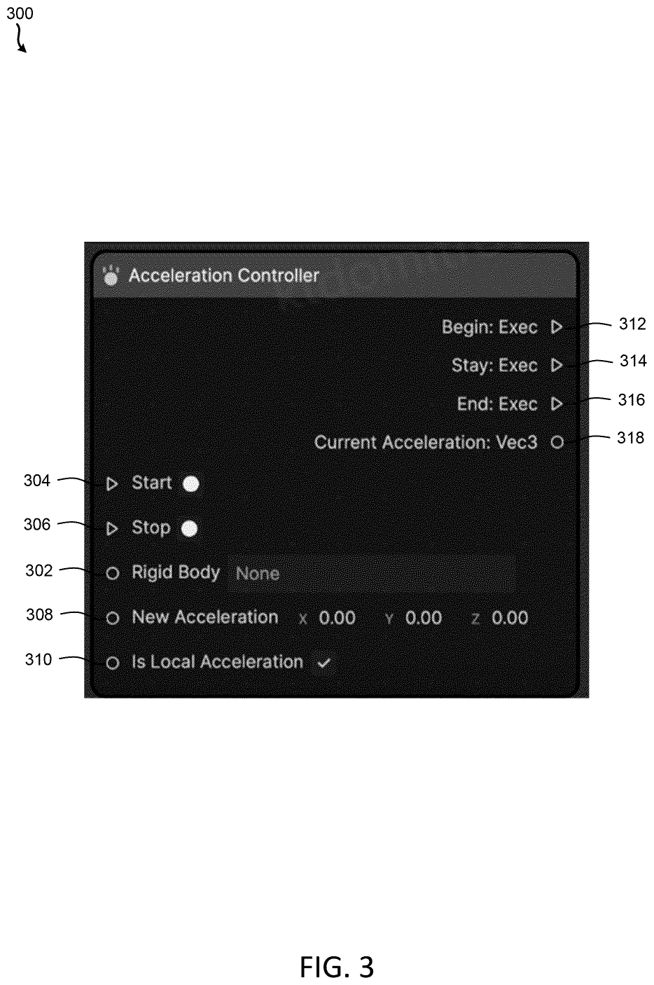

If the user selects the acceleration controller node, the content creation service 118 and/or the application 106 can cause to present the UI 300 shown in FIG. 3. The user can identify a rigid body component assigned to an object for applying the acceleration controller node using the configurable input 302. Dynamic changes in a speed and direction of the object in the 3D environment can be implemented using the acceleration controller node. For example, the acceleration of the object can be managed using the acceleration controller node.

The user can configure a start trigger for the acceleration of the object using the configurable input 304. The start trigger can indicate an event (such as the starting or stopping of another event) that triggers the acceleration of the object to begin. The user can configure the start trigger based on connecting a different node, such as a different physics controller node, to the configurable input 304. The acceleration of the object can begin (e.g., initiate) based on the different node. For example, the acceleration of the object can begin (e.g., initiate) based on the different node being initiated, during execution of the different node, or based on the different node being terminated. The user can indicate that the acceleration of the object is to begin based on a user input (e.g., a screen tap, etc.).

The user can configure a stop trigger for the acceleration of the object using the configurable input 306. The stop trigger can indicate an event (such as the starting or stopping of another event) that triggers the acceleration of the object to cease. The user can configure the stop trigger based on connecting a different node, such as a different physics controller node, to the configurable input 306. The acceleration of the object can cease (e.g., terminate) based on the different node. For example, the acceleration of the object can cease (e.g., terminate) based on the different node being initiated or based on the different node being terminated. The user can indicate that the acceleration of the object is to cease (e.g., terminate) based on a user input (e.g., a screen tap, etc.).

The user can configure a magnitude and direction of acceleration using the configurable input 308. The configurable input 308 enables the user to specify the magnitude and direction of acceleration using a three-dimensional vector. The acceleration can be measured in units per second squared. The user can specify whether the acceleration should be applied in a local space or a global (e.g., world) space using a configurable input 310.

The user can configure life cycle indicators (e.g., begin, stay, end) of the acceleration application process. The user can configure a begin indicator using the configurable output 312. The user can configure the begin indicator based on connecting a different node, such as a different physics controller node, to the configurable output 312. The different node can be executed (e.g., initiated) based on the acceleration of the object being initiated. The user can configure a stay indicator using the configurable output 314. The user can configure the stay indicator based on connecting a different node, such as a different physics controller node, to the configurable output 314. The different node can be executed (e.g., initiated) while the acceleration is applied to the object, such as for the duration of the acceleration being applied to the object. The user can configure an end indicator using the configurable output 316. The user can configure the end indicator based on connecting a different node, such as a different physics controller node, to the configurable output 316. The different node can be executed (e.g., initiated) based on the acceleration of the object being terminated. The user can configure display of a current acceleration of the object using the configurable output 318. The configurable output 318 can cause display of a real-time acceleration being applied to the object (e.g., a current acceleration in units per second squared). The user can monitor the real-time acceleration to ensure that the object is accelerating in a desired manner.

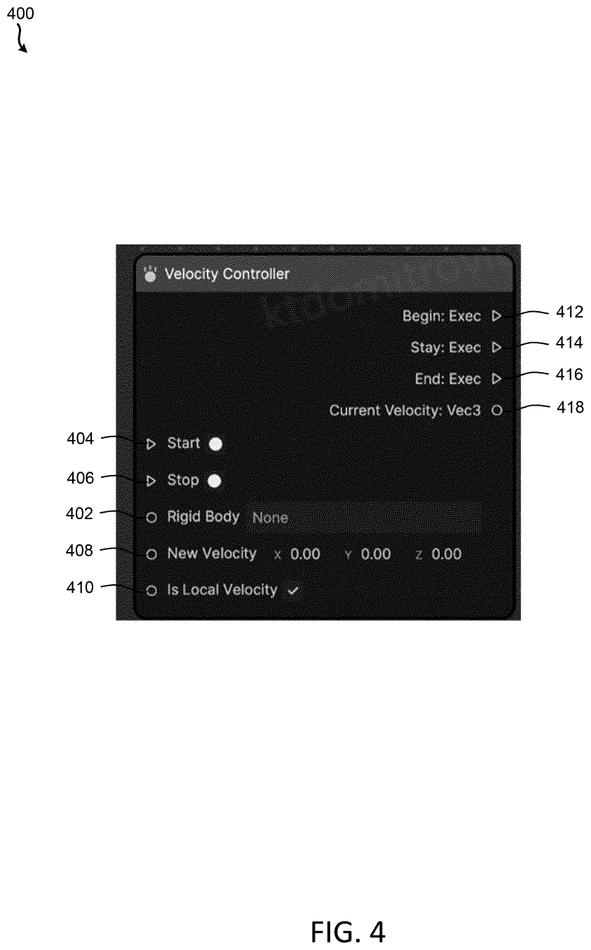

If the user selects the velocity controller node, the content creation service 118 and/or the application 106 can cause to present the UI 400 shown in FIG. 4. The user can identify a rigid body component assigned to an object for applying the velocity controller node using the configurable input 402. Precise movements and behaviors of the object in the 3D environment can be implemented using the velocity controller node. For example, the velocity of the object can be managed using the velocity controller node.

The user can configure a start trigger for the velocity of the object using the configurable input 404. The start trigger can indicate an event (such as the starting or stopping of another event) that triggers the object to begin moving at the velocity. The user can configure the start trigger based on connecting a different node, such as a different physics controller node, to the configurable input 404. The velocity of the object can begin (e.g., initiate) based on the different node. For example, the velocity of the object can begin (e.g., initiate) based on the different node being initiated or based on the different node being terminated. The user can indicate that the velocity of the object is to begin based on a user input (e.g., a screen tap, etc.).

The user can configure a stop trigger for the velocity of the object using the configurable input 406. The stop trigger can indicate an event (such as the starting or stopping of another event) that triggers the velocity of the object to cease. The user can configure the stop trigger based on connecting a different node, such as a different physics controller node, to the configurable input 406. The velocity of the object can terminate (e.g., cease) based on the different node. For example, the velocity of the object can terminate (e.g., cease) based on the different node being initiated or based on the different node being terminated. The user can indicate that the velocity of the object is to cease based on a user input (e.g., a screen tap, etc.).

The user can configure a velocity using the configurable input 408. The configurable input 408 enables the user to specify the desired velocity using a three-dimensional vector. The velocity can be measured in units per second. The user can specify whether the velocity should be set in a local space or a global (e.g., world) space using a configurable input 410.

The user can configure life cycle indicators (e.g., begin, stay, end) of the velocity application process. The user can configure a begin indicator using the configurable output 412. The user can configure the begin indicator based on connecting a different node, such as a different physics controller node, to the configurable output 412. The different node can be executed (e.g., initiated) based on the velocity of the object being initiated. The user can configure a stay indicator using the configurable output 414. The user can configure the stay indicator based on connecting a different node, such as a different physics controller node, to the configurable output 414. The different node can be executed (e.g., initiated) while the velocity is applied to the object, such as for the duration of the velocity being applied to the object. The user can configure an end indicator using the configurable output 416. The user can configure the end indicator based on connecting a different node, such as a different physics controller node, to the configurable output 416. The different node can be executed (e.g., initiated) based on the velocity of the object being terminated. The user can configure display of a current velocity of the object using the configurable output 418. The configurable output 418 can cause display of a real-time velocity being applied to the object (e.g., a current velocity in units per second squared). The user can monitor the real-time velocity to ensure that the object is moving in a desired manner.

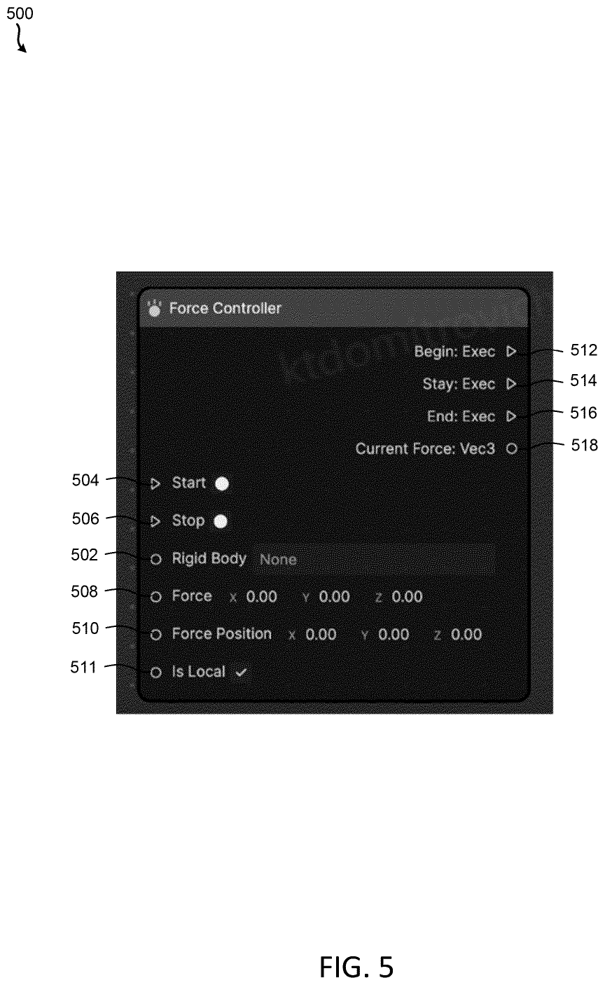

If the user selects the force controller node, the content creation service 118 and/or the application 106 can cause to present the UI 500 shown in FIG. 5. The user can identify a rigid body component assigned to an object for applying the force controller node using the configurable input 502. Sustained movements or interactions of the object in the 3D environment can be implemented using the force controller node. For example, a continuous force on the object can be managed using the force controller node.

The user can configure a start trigger for applying the continuous force on the object using the configurable input 504. The start trigger can indicate an event (such as the starting or stopping of another event) that triggers the continuous force to begin being applied on the object. The user can configure the start trigger based on connecting a different node, such as a different physics controller node, to the configurable input 504. The continuous force can begin being applied on the object based on the different node. For example, the continuous force can begin being applied on the object based on the different node being initiated or based on the different node being terminated. The user can indicate that the continuous force is to begin being applied on the object based on a user input (e.g., a screen tap, etc.).

The user can configure a stop trigger for applying the continuous force on the object using the configurable input 506. The stop trigger can indicate an event (such as the starting or stopping of another event) that triggers the continuous force to stop being applied on the object. The user can configure the stop trigger based on connecting a different node, such as a different physics controller node, to the configurable input 506. The continuous force can stop being applied on the object based on the different node. For example, the continuous force of the object can stop being applied on the object based on the different node being initiated or based on the different node being terminated. The user can indicate that the continuous force is to stop being applied on the object based on a user input (e.g., a screen tap, etc.).

The user can configure the magnitude and direction of the continuous force using the configurable input 508. The configurable input 508 enables the user to specify the magnitude and direction of the continuous force using a three-dimensional vector. The user can configure the position of the continuous force using the configurable input 510. The configurable input 510 enables the user to specify the point on the object where the continuous force is applied, which can affect torque. The continuous force can be measured in units. The user can specify whether the continuous force should be set in a local space or a global (e.g., world) space using a configurable input 511.

The user can configure life cycle indicators (e.g., begin, stay, end) of the continuous force application process. The user can configure a begin indicator using the configurable output 512. The user can configure the begin indicator based on connecting a different node, such as a different physics controller node, to the configurable output 512. The different node can be executed (e.g., initiated) based on the continuous force being initiated. The user can configure a stay indicator using the configurable output 515. The user can configure the stay indicator based on connecting a different node, such as a different physics controller node, to the configurable output 515. The different node can be executed (e.g., initiated) while the continuous force is being applied to the object, such as for the duration of the continuous force being applied to the object. The user can configure an end indicator using the configurable output 516. The user can configure the end indicator based on connecting a different node, such as a different physics controller node, to the configurable output 516. The different node can be executed (e.g., initiated) based on the continuous force being terminated. The user can configure display of a current force being applied the object using the configurable output 518. The configurable output 518 can cause display of a real-time force being applied to the object. The user can monitor the real-time force to ensure that the desired force is being applied on the object.

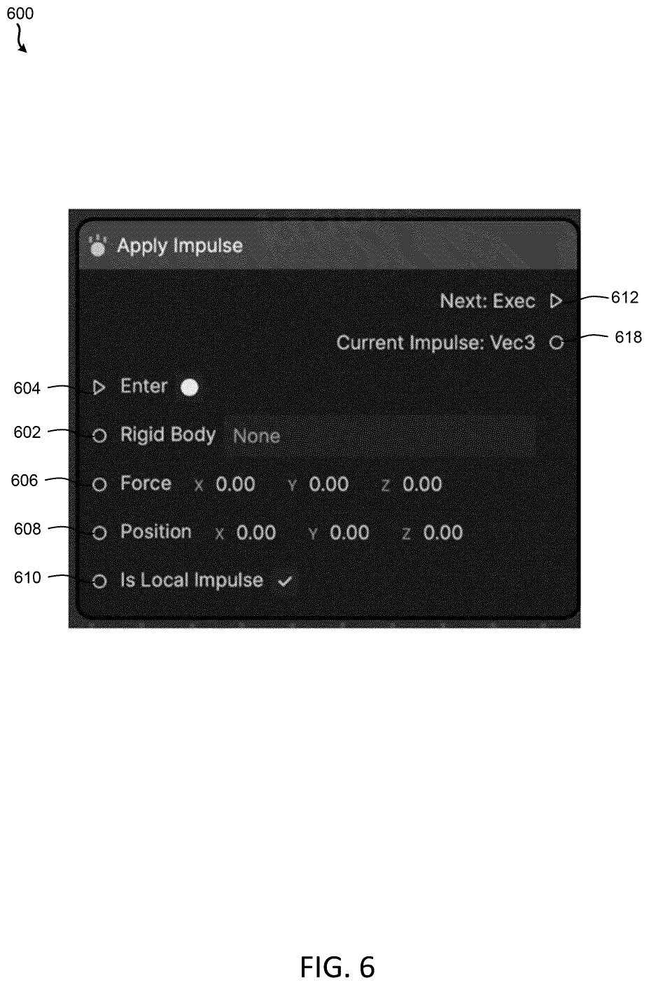

If the user selects the impulse controller node, the content creation service 118 and/or the application 106 can cause to present the UI 600 shown in FIG. 6. The user can identify a rigid body component assigned to an object for applying the impulse controller node using the configurable input 602. Realistic impacts on and movements of the object in the 3D environment can be simulated using the impulse controller node. For example, an instantaneous force on the object can be managed using the impulse controller node.

The user can configure a start trigger for applying the instantaneous force on the object using the configurable input 604. The start trigger can indicate an event (such as the starting or stopping of another event) that triggers the instantaneous force to begin being applied on the object. The user can configure the start trigger based on connecting a different node, such as a different physics controller node, to the configurable input 604. The instantaneous force can begin being applied on the object based on the different node. For example, the instantaneous force can begin being applied on the object based on the different node being initiated or based on the different node being terminated. The user can indicate that the instantaneous force is to begin being applied on the object based on a user input (e.g., a screen tap, etc.).

The user can configure the magnitude and direction of the instantaneous force using the configurable input 606. The configurable input 606 enables the user to specify the magnitude and direction of the instantaneous force using a three-dimensional vector. The user can configure the position of the instantaneous force using the configurable input 608. The configurable input 608 enables the user to specify the point on the object (e.g., relative to the center of the object) where the instantaneous force is applied. The instantaneous force can be measured in units. The user can specify whether the instantaneous force should be set in a local space or a global (e.g., world) space using a configurable input 610.

The user can configure a life cycle indicator (e.g., next) of the instantaneous force application process. The user can configure the next life cycle indicator using the configurable output 612. The user can configure the next life cycle indicator based on connecting a different node, such as a different physics controller node, to the configurable output 612. The different node can be executed (e.g., initiated) based on the instantaneous force being applied. The user can configure display of the current instantaneous force being applied the object using the configurable output 618. The configurable output 618 can cause display of information (e.g., feedback) on the most recent impulse force applied. The user can monitor the feedback to ensure that the desired instantaneous force is being applied on the object.

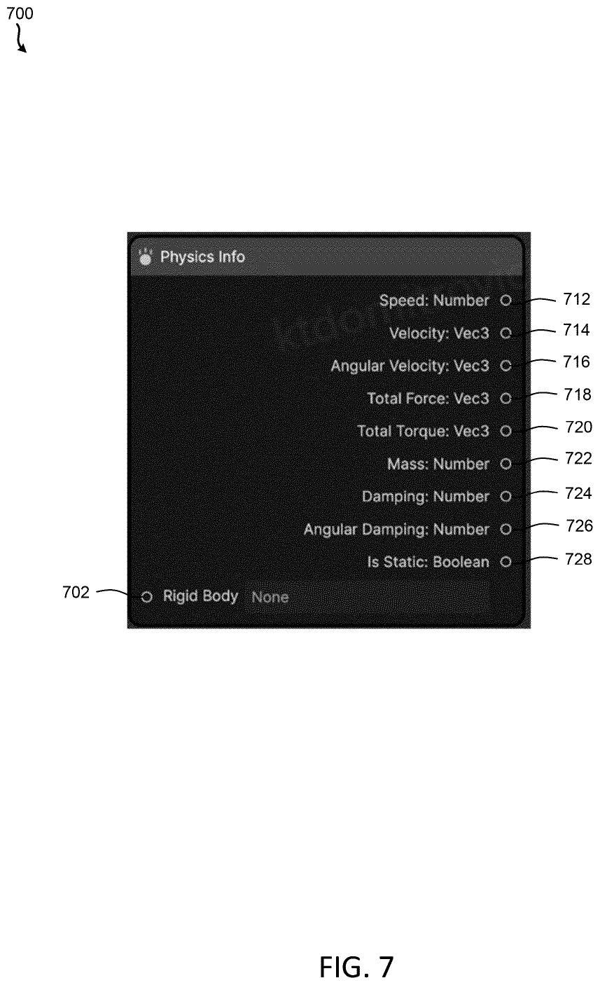

If the user selects the physics information node, the content creation service 118 and/or the application 106 can cause to present the UI 700 shown in FIG. 7. The user can identify a rigid body component assigned to an object for applying the physics information node using the configurable input 702. Real-time physics properties of the object in the 3D environment can be displayed via the outputs 712-728. The output 712 can display a speed, such as a scalar magnitude of the velocity, of the object. The output 714 can display a velocity, such as a speed and direction of movement, of the object. The output 716 can display an angular velocity, such as a rate and axis of rotation, of the object. The output 718 can display a total force on the object, such as a sum of all forces acting on the body of the object. The output 720 can display a total torque, such as a sum of all torques, on the object. The output 722 can display a mass of the object. The output 724 can display a damping of the object, such as the resistance of the object to linear motion. The output 726 can display an angular damping of the object, such as a resistance of the object to rotational motion. The output 728 can indicate if the object is static (e.g., immovable).

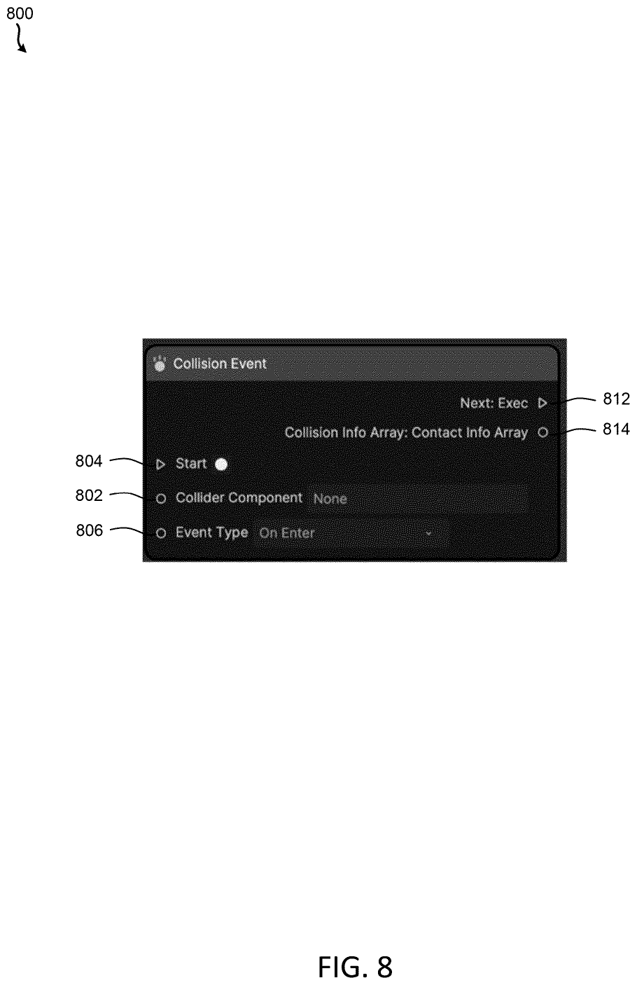

If the user selects the collision event node, the content creation service 118 and/or the application 106 can cause to present the UI 800 shown in FIG. 8. The user can identify a collider component assigned to object(s) for applying the collision event node using the configurable input 802. The object(s) can be monitored for collisions. Collisions between objects in the 3D environment can be detected and particular responses of the objects to the collisions can be triggered using the collision event node.

The user can configure a start trigger for detecting a collision using the configurable input 804. The start trigger can indicate an event (such as the starting or stopping of another event) that triggers the collision detection to begin. The user can configure the start trigger based on connecting a different node, such as a different physics controller node, to the configurable input 804. The collision detection can begin based on the different node. For example, the collision detection can begin based on the different node being initiated or based on the different node being terminated. The user can indicate that the collision detection is to begin based on a user input (e.g., a screen tap, etc.). The user can configure an event type of the collision using the configurable input 806. The event type can specify the phase of collision to detect (e.g., enter, stay, or exit).

The user can configure a life cycle indicator (e.g., next) of the collision detection process. The user can configure the next life cycle indicator using the configurable output 812. The user can configure the next life cycle indicator based on connecting a different node, such as a different physics controller node, to the configurable output 812. The different node can be executed (e.g., initiated) based on the collision being detected. The user can configure display of information related to the collision detection using the configurable output 814. The configurable output 814 can cause display of detailed information (e.g., feedback) on each collision event. The user can monitor the feedback to ensure that the desired collisions are occurring in the 3D environment.

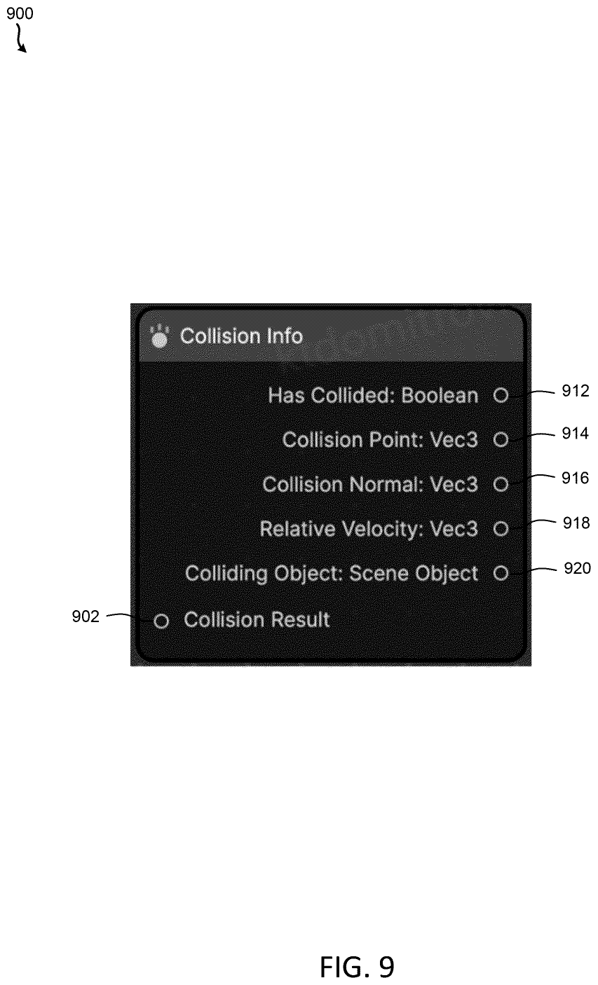

If the user selects the collision information node, the content creation service 118 and/or the application 106 can cause to present the UI 900 shown in FIG. 9. The user can assign a collision result to the collision information node using the configurable input 902. The assigned collision result can specify which collision event node to collect incoming collision data from. Information about the specified collision event can be displayed via the outputs 912-920. The output 912 can indicate whether a collision has occurred. The output 914 can display a world space location of the collision. The output 916 can display a normal vector at the collision point. The output 918 can display a speed and direction of the colliding objects at the point of collision. The output 920 can display the colliding object (e.g., the object that was collided with).

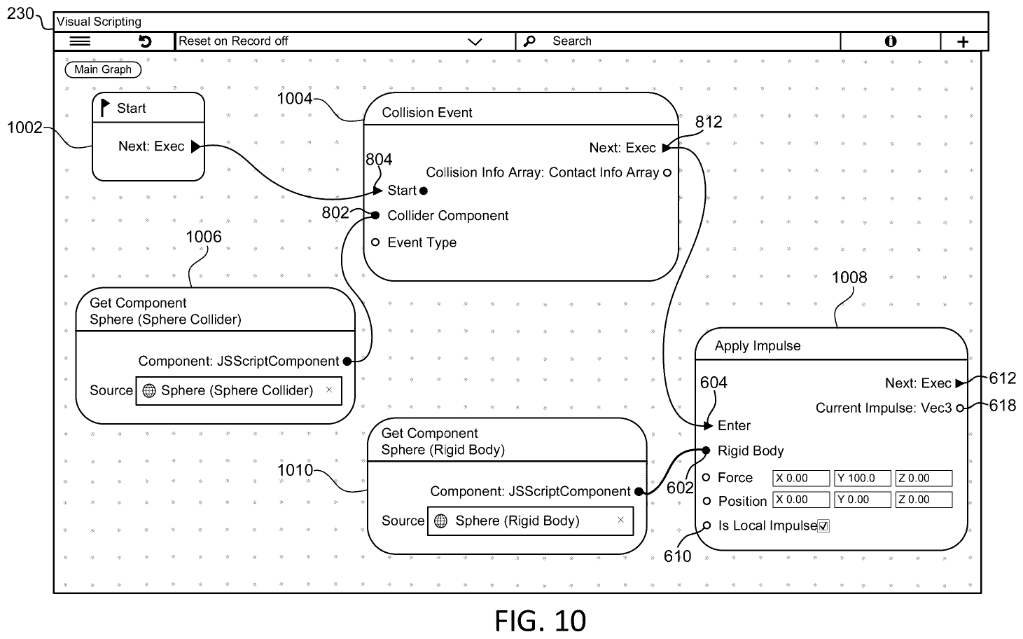

FIG. 10 shows an example visual scripting window 230. The user can add a start node 1002 to the visual scripting window 230, such as by selecting the button 232, left clicking in the visual scripting window 230, and/or use the search bar 234. The start node 1002 can indicate a start of the sequence of interconnected nodes configured to govern the application of physics principles to objects in the 3D environment. The user can configure a start trigger for the start node 1002. The start trigger can indicate an event that triggers the initiation of the execution of the sequence of interconnected nodes. For example, the user can indicate that execution of the sequence of interconnected nodes is to be initiated based on a certain time or based on a user input (e.g., a screen tap, initiation of game play, etc.).

The user can configure a life cycle indicator (e.g., next) of the start node 1002. The user can configure the next life cycle indicator based on connecting a different node, such as a collision event node 1004, to the start node 1002. For example, the user can connect the start node 1002 to the configurable input 804 of the collision event node 1004. Based on the user connecting the start node 1002 to the configurable input 804 of the collision event node 1004, the content creation service 118 and/or the application 106 can cause the collision event node 1004 to execute (e.g., initiate) based on the start trigger of the start node 1002. Causing the collision event node 1004 to execute (e.g., initiate) can include initiating the process of collision detection.

The user can assign a collider component to the collision event node 1004 using the configurable input 802. For example, the user can connect a component node 1006 to the configurable input 802. The component node 1006 can indicate which component are to be monitored for collisions. In the example of FIG. 10, a sphere collider component is to be monitored.

The user can configure a life cycle indicator (e.g., next) of the collision detection process. The user can configure the next life cycle indicator using the configurable output 812. For example, the user can connect a configurable input 604 of an impulse controller node 1008 to the configurable output 812 of the collision event node 1004. Based on the user connecting the configurable input 604 of the impulse controller node 1008 to the configurable output 812 of the collision event node 1004, the content creation service 118 and/or the application 106 can cause the impulse controller node 1008 to execute (e.g., initiate) based on the detection of a collision. Causing the impulse controller node 1008 to execute (e.g., initiate) can include causing an instantaneous force to be applied.

The user can assign a rigid body component to the impulse controller node 1008 using the configurable input 602. For example, the user can connect a component node 1010 to the configurable input 602. The component node 1010 can indicate which object the instantaneous force is to be applied to. In the example of FIG. 10, the instantaneous force is to be applied to a sphere rigid body. The user can specify a frame of reference for the instantaneous force. The user can specify whether the instantaneous force should be set in a local space or a global (e.g., world) space using the configurable input 610. In the example of FIG. 10, the user has indicated that the content creation service 118 and/or the application 106 is to apply the instantaneous force in a local space.

The user can configure a life cycle indicator (e.g., next) of the instantaneous force application process. The user can configure the next life cycle indicator using the configurable output 612. The user can configure the next life cycle indicator based on connecting a different node, such as a different physics controller node, to the configurable output 612. The different node can be executed (e.g., initiated) based on the instantaneous force being applied to the specific object. The user can configure display of the current instantaneous force being applied the object using the configurable output 618. The configurable output 618 can cause display of information (e.g., feedback) on the most recent impulse force applied. The user can monitor the feedback to ensure that the desired instantaneous force is being applied on the object.

The content creation service 118 and/or the application 106 can execute the sequence of nodes in the order specified by the user and based on the user-defined parameters associated with each of the nodes to refine the physics simulations in the 3D environment. In this manner, the visual scripting window 230 provides a user-friendly interface for visually scripting complex physics interactions within AR environments.

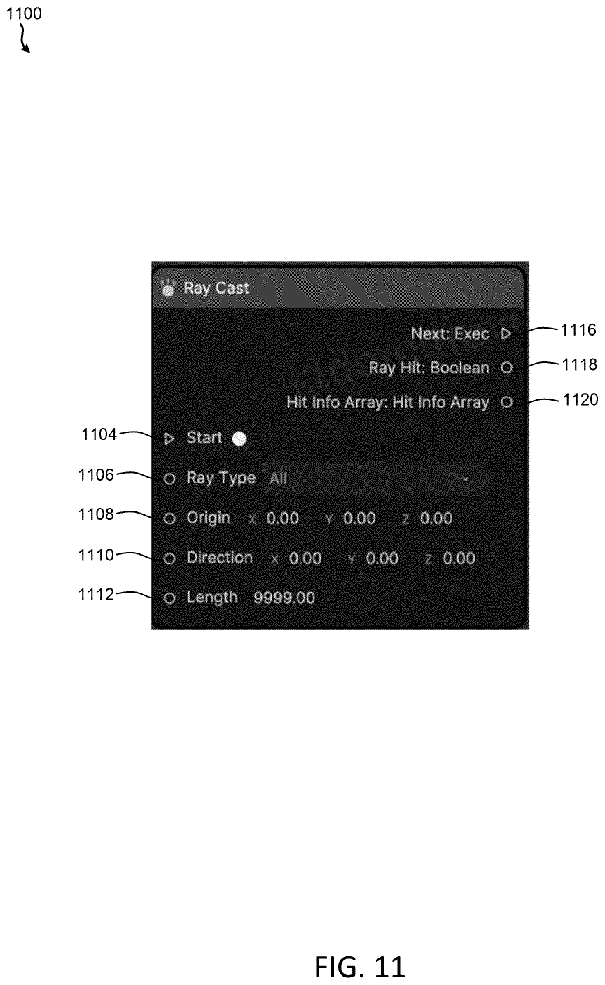

If the user selects the ray cast node, the content creation service 118 and/or the application 106 can cause to present the UI 1100 shown in FIG. 11. A ray can be projected. Line-of-sight interactions and distance measurements associated with the projected ray can be facilitated in the 3D environment using the UI 1100.

The user can configure a start trigger for initiating the ray cast using the configurable input 1104. The start trigger can indicate an event (such as the starting or stopping of another event in the 3D environment) that triggers the initiation of the ray cast. The user can configure the start trigger based on connecting a different node, such as a different physics controller node, to the configurable input 1104. The ray cast can be initiated based on the different node. For example, the ray cast can be initiated based on the different node being initiated or based on the different node being terminated. The user can indicate that the ray cast is to be initiated based on a user input (e.g., a screen tap, etc.).

The user can configure a ray type for the ray cast using the configurable input 1106. The ray type can specify the detection mode (all or nearest) for the ray cast. The user can configure an origin of the ray cast using the configurable input 1108. The origin can indicate the starting point of the ray. The origin can be a three-dimensional vector. The user can configure a direction of the ray cast using the configurable input 1110. The direction can indicate the normalized direction of the ray. The direction can be a three-dimensional vector. The user can configure a length of the ray cast using the configurable input 1112. The length of the ray cast can indicate how far the ray extends in the 3D environment.

The user can configure a life cycle indicator (e.g., next) of the ray cast. The user can configure the next life cycle indicator using the configurable output 1116. The user can configure the next life cycle indicator based on connecting a different node, such as a different physics controller node, to the configurable output 1116. The different node can be executed (e.g., initiated) based on the ray being cast. The user can configure display of information about the ray using the configurable output 1118. The configurable output 1118 can indicate if the ray hit an object. The user can configure display of information about the ray using the configurable output 1120. The configurable output 1120 can cause display of information (e.g., feedback) on the objects hit by the ray. The user can monitor the feedback to ensure that the ray is hitting the desired objects.

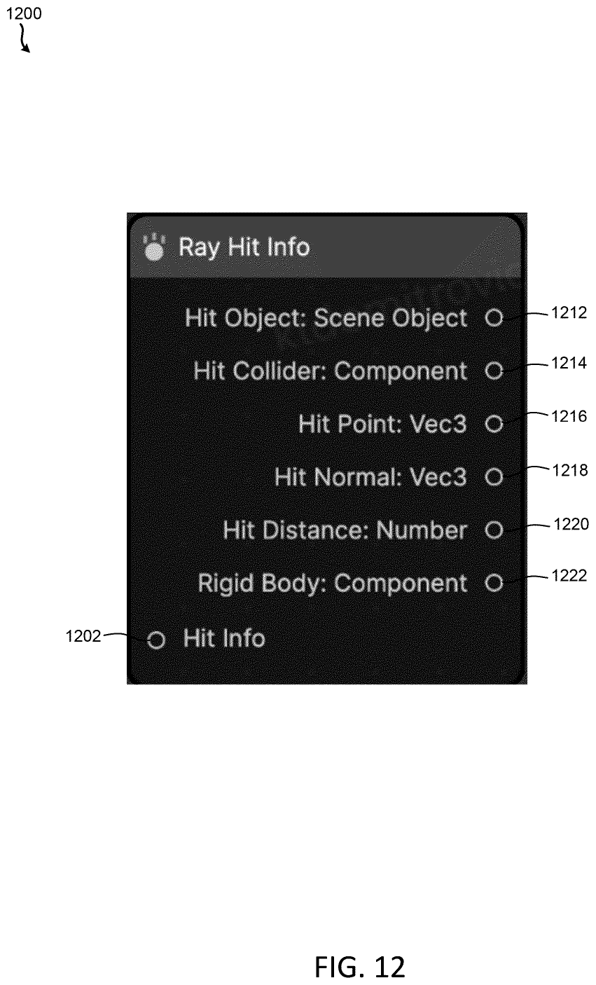

If the user selects the ray hit information node, the content creation service 118 and/or the application 106 can cause to present the UI 1200 shown in FIG. 12. The user can specify ray hit information using the configurable input 1202. The ray hit information can indicate information from the ray cast node.

The user can view detailed information about hit objects using the configurable outputs 1212-1222. The user can view a hit object using the configurable output 1212. The configurable output 1212 can display the object that was hit by the ray. The user can view a hit collider using the configurable output 1214. The configurable output 1214 can indicate the specific collider that was hit by the ray. The user can view a hit point using the configurable output 1216. The configurable output 1216 can indicate a location of the hit (e.g., the ray hitting the object) in world space. The location can be displayed as a three-dimensional array. The user can view a hit normal using the configurable output 1218. The configurable output 1218 can indicate a normal vector at the hit point. The normal vector can be displayed as a three-dimensional array. The user can view a hit distance using the configurable output 1220. The configurable output 1220 can indicate a distance from the origin of the ray to the hit. The user can view a rigid body using the configurable output 1222. The configurable output 1222 can indicate the rigid body of the hit object, if any.

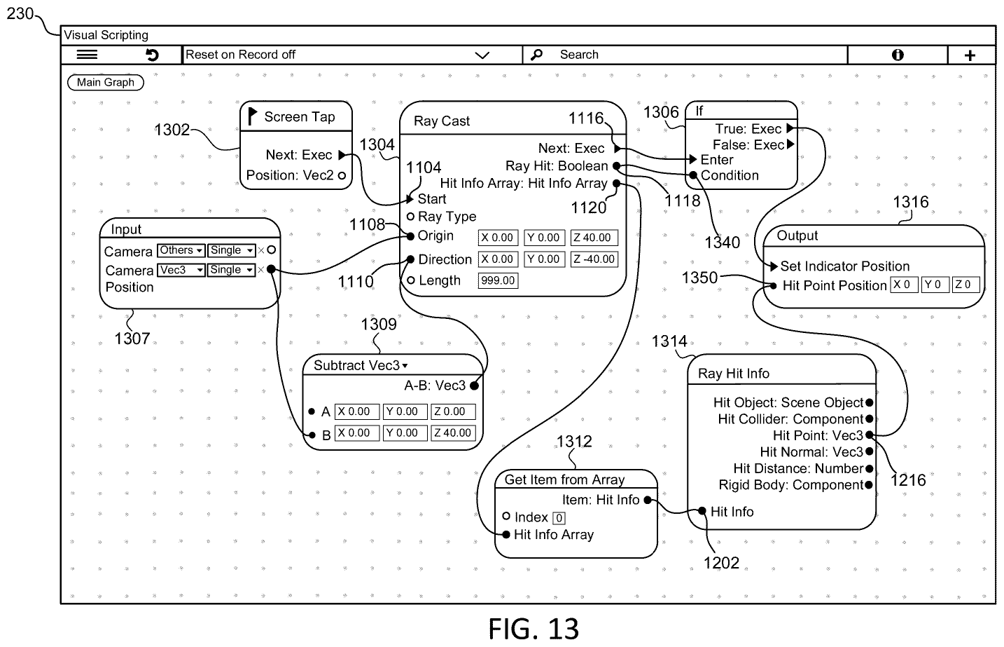

FIG. 13 shows an example visual scripting window 230. The user can add a start node 1302 to the visual scripting window 230, such as by selecting the button 232, left clicking in the visual scripting window 230, and/or use the search bar 234. The start node 1302 can indicate a start of the sequence of interconnected nodes configured to govern the application of physics principles to objects in the 3D environment. The user can configure a start trigger for the start node 1302. The start trigger can indicate an event that triggers the initiation of the execution of the sequence of interconnected nodes. For example, the user can indicate that execution of the sequence of interconnected nodes is to be initiated based on a user input (e.g., a screen tap, initiation of game play, etc.).

The user can configure a life cycle indicator (e.g., next) of the start node 1302. The user can configure the next life cycle indicator based on connecting a different node, such as a ray cast node 1304, to the start node 1302. For example, the user can connect the start node 1302 to the configurable input 1104 of the ray cast node 1304. Based on the user connecting the start node 1002 to the configurable input 1104 of the ray cast node 1304, the content creation service 118 and/or the application 106 can cause the ray cast node 1304 to execute (e.g., initiate) based on the start trigger of the start node 1302. Causing the ray cast node 1304 to execute (e.g., initiate) can include causing a ray to be cast (e.g., projected) in the 3D environment.

The user can configure an origin of the ray cast using the configurable input 1108. For example, the user can connect an input node 1307 to the configurable input 1108. The input node 1307 can indicate the origin of the ray cast. The origin can indicate the starting point of the ray. The origin can be a three-dimensional vector. In the example of FIG. 13, by connecting the input node 1307 to the configurable input 1108, the user has indicated that the origin of the ray cast is a three-dimensional vector corresponding to a real-time camera position. The user can configure a direction of the ray cast using the configurable input 1110. For example, the user can connect a subtract vector node 1309 to the configurable input 1110. The subtract vector node 1309 can indicate two three-dimensional vectors. The difference between the two three-dimensional vectors can indicate the direction of the ray cast. In the example of FIG. 13, by connecting the subtract vector node 1309 to the input node 1307, the user has indicated that one of three-dimensional vectors used to determine the direction of the ray cast a three-dimensional vector corresponding to a real-time camera position.

The user can configure a life cycle indicator (e.g., next) of the ray cast. The user can configure the next life cycle indicator using the configurable output 1116. The user can configure the next life cycle indicator based connecting an “if” node to the configurable output 1116. The “if” node can be executed (e.g., initiated) based on the ray being cast. Executing the “if” node can include executing an output node 1316 based on a condition being satisfied. The user can configure the condition based on connecting the condition input 1340 of the “if” node to the configurable output 1118 of the ray cast node 1304. The configurable output 1118 can indicate if the ray hit an object. By connecting the condition input 1340 of the “if” node to the configurable output 1118 of the ray cast node 1304, the user can cause the content creation service 118 and/or the application 106 to executing the output node 1316 based on the ray hitting an object. The content creation service 118 and/or the application 106 may not execute the output node 1316 if the ray does not hit an object.

In the example of FIG. 13, executing the output node 1316 can cause an indicator position in the 3D environment to be set. The indicator position can be set based on the location (e.g., position) at which the ray hit the object. The user can configure the indicator position based on connecting a hit ray information node 1314 to a configurable input 1350 of the output node 1316. For example, the user can configure the indicator position based on connecting the configurable output 1216 of the hit ray information node 1314 to the configurable input 1350 of the output node 1316. The configurable output 1216 can indicate a location of the hit (e.g., the ray hitting the object) in world space. The location can be a three-dimensional array. The user can configure an input to the hit ray information node 1314 using the configurable input 1202. To configure the input to the hit ray information node 1314, the user can connect a “get item” array 1312 to the configurable input 1202. The “get item” array 1312 can be connected to the configurable output 1120 of the ray cast node 1304.

Referring back to FIG. 1, the content creation service 118 and/or the application 106 can customize and/or optimize the physics simulations in the 3D environment can be configured based on user input received via user interfaces (e.g., UIs 200, 300, 400, 500, 600, 700, 800, 900, 1000, 1100, 1200, 1300, and/or 1400). The content creation service 118 and/or the application 106 can facilitate to refine the content based on the customized and/or optimized physics simulations. If the created content is an effect, such as an interactive effect, the content can be stored locally or stored as effect data 121 in the database 123. If the created content is a game, the content can be stored locally or stored as game data 129 in the database 123. The stored content can be used by other users. For example, the content creation service 118 can distribute the stored effect data 121 to other client devices. Users associated with the other client devices can utilize the effect data 121 to generate content, such as images or videos. Similarly, the content creation service 118 can distribute the stored game data 129 to other client devices. Users associated with the other client devices can utilize the game data 129 to play the associated game and/or to generate content associated with the game data 129.

It should be appreciated that, while the content creation service 118 can facilitate the creation/design of content in the manner described above, the client devices 104 can additionally, or alternatively, facilitate the local creation/design of content using the set of physics controller nodes 116. For example, the client devices 104, via the application 106, can establish the set of physics controller nodes 116. The set of physics controller nodes 116 can be stored locally on the client devices 104. Alternatively, the client devices 104 can receive (e.g., retrieve) data indicative of the set of physics controller nodes 116 from a remote storage, such as from the cloud network 102. The client devices 104 can present user interfaces (e.g., UI 200-1300), such as via the interface 108 of the application 106. The user interfaces can facilitate refinement of the physics simulations in the 3D environment. The client devices 104 can customize and optimize the physics simulations utilizing the set of physics controller nodes based on user input received via the user interfaces.

By using the set of physics controller nodes 116, the content creation service 118 and/or the application 106 described above can simplify the content creation process by abstracting complex physics calculations and interactions into intuitive nodes. Creators can design sophisticated AR experiences without having a deep programming knowledge, thereby lowering the barrier to entry. The set of physics controller nodes 116 can enhanced interactivity and realism within AR environments by enabling more dynamic and responsive interactions within the AR environment. The set of physics controller nodes 116 can enable rapid prototyping and iteration during the content creation process. With real-time feedback on physics behaviors provided by nodes such as the physics information node, the collision information node, and/or the ray hit information node, developers can quickly prototype, test, and refine AR experiences, significantly speeding up the development process.

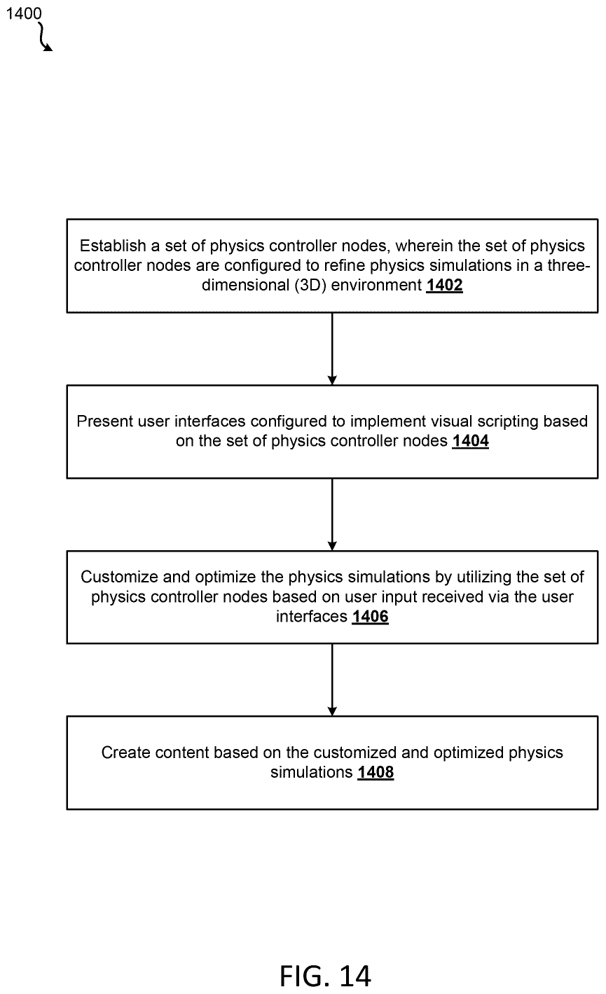

FIG. 14 illustrates an example process 1400 for creating physics-based content in accordance with the present disclosure. The process 1400 can be performed, for example, by the content creation service 118 and/or the application 106. Although depicted as a sequence of operations in FIG. 14, those of ordinary skill in the art will appreciate that various embodiments may add, remove, reorder, or modify the depicted operations.

At 1402, a set of physics controller nodes (e.g., set of physics controller nodes 116) can be established. The set of physics controller nodes can be configured to refine physics simulations in a 3D environment. The set of physics controller nodes can include an acceleration controller node. The acceleration controller node be used to manage the acceleration of objects, enabling dynamic changes in the speed and direction. The set of physics controller nodes can further include an impulse node. The impulse node can be used to apply instantaneous force to objects, simulating realistic impacts and movements. The set of physics controller nodes can further include a force controller node. The force controller node can be used to cause continuous application of force to objects, enabling sustained movements or interactions. The set of physics controller nodes can further include a velocity controller node. The velocity controller node can be used to directly control the velocity of objects, facilitating precise movements and behaviors. The set of physics controller nodes can further include a physics information node. The physics information node can be used to gathers and display real-time physics properties of objects, such as velocity and mass, aiding in debugging and development during the content creation process.

The set of physics controller nodes can further include a collision event node. The collision event node can be used to detect collisions between objects, triggering specific responses or behaviors. The set of physics controller nodes can further include a collision information node. The collision information node can be used to provides detailed information, such as real-time information, about collision events, including the objects involved in the collision and points of impact associated with the collision. The set of physics controller nodes can further include a ray cast node. The ray cast node can be used to project an invisible ray in the 3D environment to detect objects in the path of the invisible ray. The ray cast node can be useful for line-of-sight interactions and/or distance measurements. The set of physics controller nodes can further include a ray hit information node. The ray hit information node can be used to capture and relay information about objects hit by a ray cast, including distance and hit location.

At 1404, user interfaces (e.g., UIs 200-1300) can be presented. The user interfaces can be configured to implement visual scripting based on the set of physics controller nodes. A user can input, via one or more of the user interfaces, data indicating a desired customization and optimization of physics simulations in the 3D environment. At 1406, the physics simulations can be customized and optimized by utilizing the set of physics controller nodes. The physics simulations can be customized and optimized based on user input received via the user interfaces. At 1408, content can be created. The content can be created based on the customized and optimized physics simulations. The content can include, for example, interactive effects, such as AR effects and/or games.

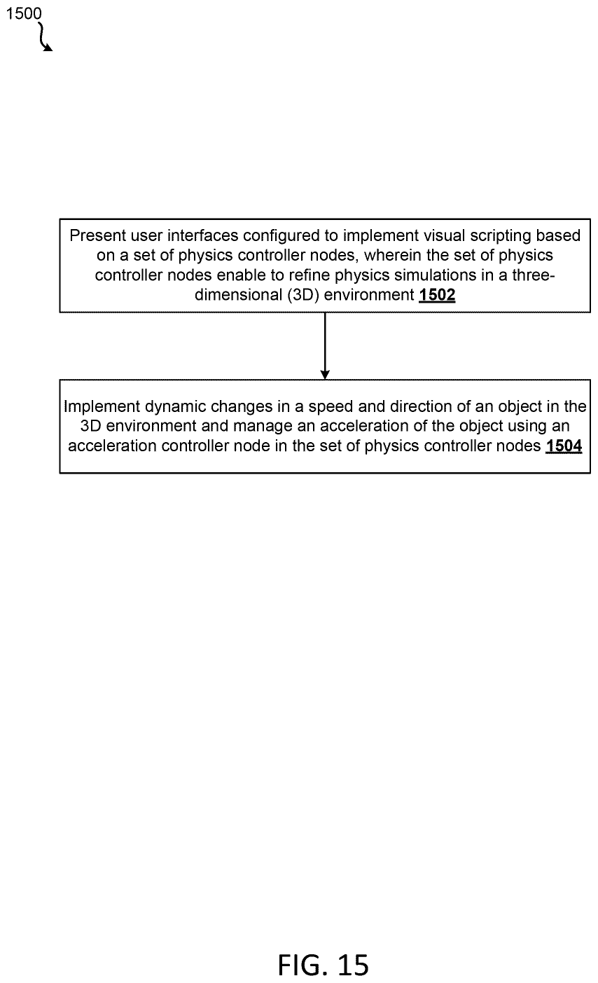

FIG. 15 illustrates an example process 1500 for creating physics-based content in accordance with the present disclosure. The process 1500 can be performed, for example, by the content creation service 118 and/or the application 106. Although depicted as a sequence of operations in FIG. 15, those of ordinary skill in the art will appreciate that various embodiments may add, remove, reorder, or modify the depicted operations.

At 1502, user interfaces (e.g., UIs 200-1300) can be presented. The user interfaces can be configured to implement visual scripting based on a set of physics controller nodes. The set of physics controller nodes enable to refine physics simulations in a 3D environment. The set of physics controller nodes can include an acceleration controller node. The acceleration controller node be used to manage the acceleration of objects, enabling dynamic changes in the speed and direction. At 1504, dynamic changes in a speed and direction of an object in the 3D environment can be implemented using the acceleration controller node. An acceleration of the object can be managed using the acceleration controller node.

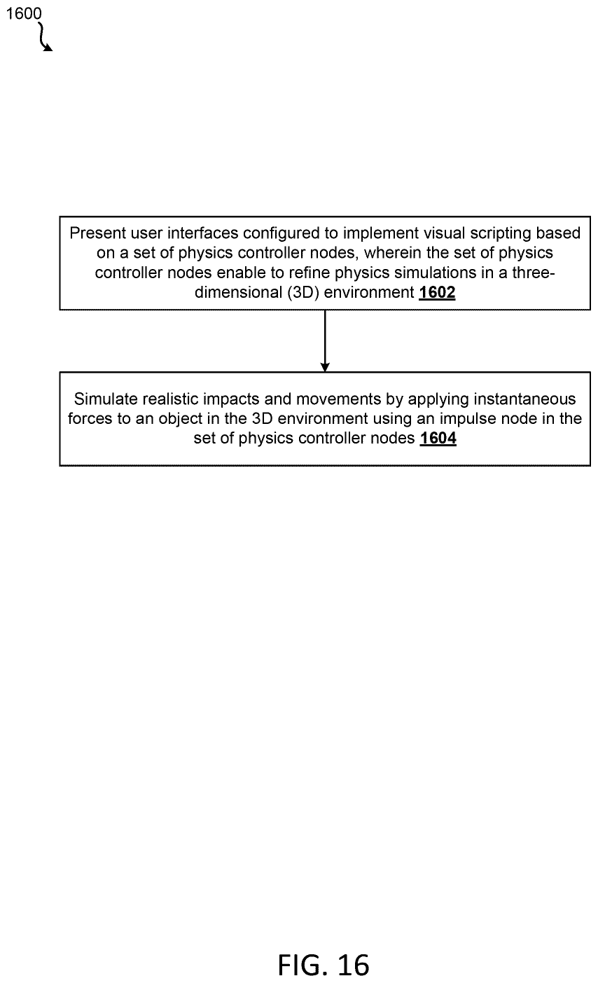

FIG. 16 illustrates an example process 1600 for creating physics-based content in accordance with the present disclosure. The process 1600 can be performed, for example, by the content creation service 118 and/or the application 106. Although depicted as a sequence of operations in FIG. 16, those of ordinary skill in the art will appreciate that various embodiments may add, remove, reorder, or modify the depicted operations.

At 1602, user interfaces (e.g., UIs 200-1300) can be presented. The user interfaces can be configured to implement visual scripting based on a set of physics controller nodes. The set of physics controller nodes enable to refine physics simulations in a 3D environment. The set of physics controller nodes can include an impulse node. The impulse node can be used to apply instantaneous force to objects, simulating realistic impacts and movements. At 1604, realistic impacts and movements can be simulated. The realistic impacts and movements can be simulated by applying instantaneous forces to an object in the 3D environment using the impulse node.

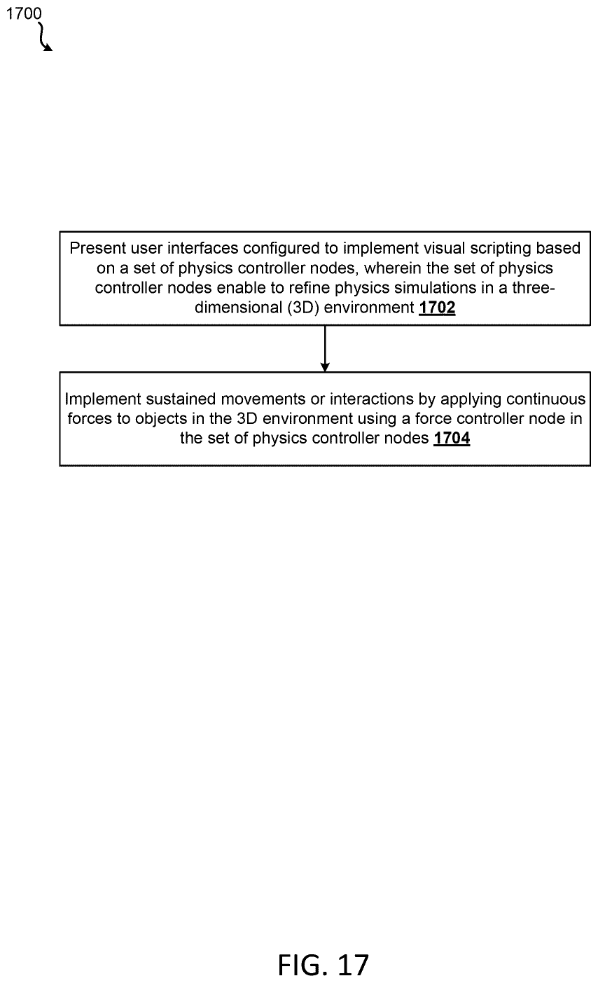

FIG. 17 illustrates an example process 1700 for creating physics-based content in accordance with the present disclosure. The process 1700 can be performed, for example, by the content creation service 118 and/or the application 106. Although depicted as a sequence of operations in FIG. 17, those of ordinary skill in the art will appreciate that various embodiments may add, remove, reorder, or modify the depicted operations.

At 1702, user interfaces (e.g., UIs 200-1300) can be presented. The user interfaces can be configured to implement visual scripting based on a set of physics controller nodes. The set of physics controller nodes enable to refine physics simulations in a 3D environment. The set of physics controller nodes can include a force controller node. The force controller node can be used to cause continuous application of force to objects, enabling sustained movements or interactions. At 1704, sustained movements or interactions can be implemented. The sustained movements or interactions can be implemented by applying continuous forces to objects in the 3D environment using the force controller node.

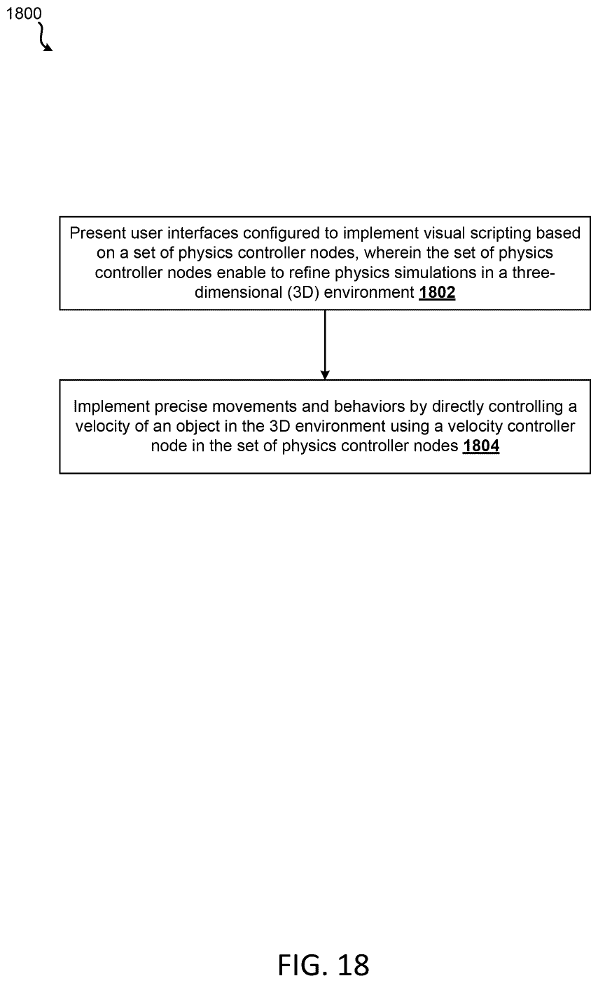

FIG. 18 illustrates an example process 1800 for creating physics-based content in accordance with the present disclosure. The process 1800 can be performed, for example, by the content creation service 118 and/or the application 106. Although depicted as a sequence of operations in FIG. 18, those of ordinary skill in the art will appreciate that various embodiments may add, remove, reorder, or modify the depicted operations.

At 1802, user interfaces (e.g., UIs 200-1300) can be presented. The user interfaces can be configured to implement visual scripting based on a set of physics controller nodes. The set of physics controller nodes enable to refine physics simulations in a 3D environment. The set of physics controller nodes can further include a velocity controller node. The velocity controller node can be used to directly control the velocity of objects, facilitating precise movements and behaviors. At 1804, precise movements and behaviors of objects in the 3D environment can be implemented. The precise movements and behaviors of the objects can be implemented by directly controlling a velocity of the object in the 3D environment using the velocity controller node.

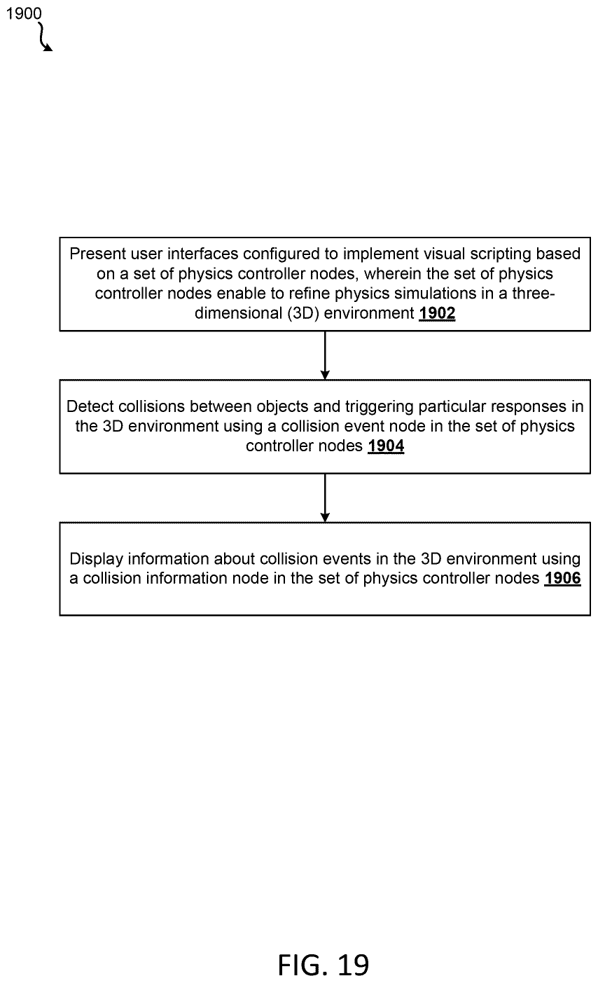

FIG. 19 illustrates an example process 1900 for creating physics-based content in accordance with the present disclosure. The process 1900 can be performed, for example, by the content creation service 118 and/or the application 106. Although depicted as a sequence of operations in FIG. 19, those of ordinary skill in the art will appreciate that various embodiments may add, remove, reorder, or modify the depicted operations.

At 1902, user interfaces (e.g., UIs 200-1300) can be presented. The user interfaces can be configured to implement visual scripting based on a set of physics controller nodes. The set of physics controller nodes enable to refine physics simulations in a 3D environment. The set of physics controller nodes can include a collision event node. The collision event node can be used to detect collisions between objects, triggering specific responses or behaviors. The set of physics controller nodes can further include a collision information node. The collision information node can be used to provides detailed information, such as real-time information, about collision events, including the objects involved in the collision and points of impact associated with the collision.

At 1904, collisions between objects can be detected using the collision event node. Particular responses to the collisions can be triggered in the 3D environment using the collision event node. At 1906, information about collision events in the 3D environment can be displayed. The information about the collision events in the 3D environment can be displayed using the collision information node.

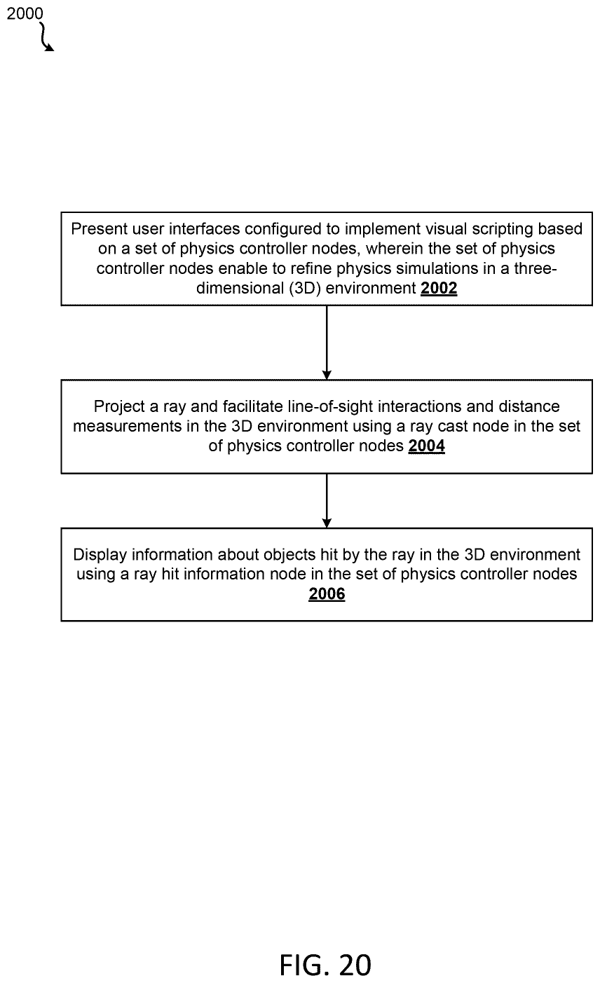

FIG. 20 illustrates an example process 2900 for creating physics-based content in accordance with the present disclosure. The process 2000 can be performed, for example, by the content creation service 118 and/or the application 106. Although depicted as a sequence of operations in FIG. 20, those of ordinary skill in the art will appreciate that various embodiments may add, remove, reorder, or modify the depicted operations.

At 2002, user interfaces (e.g., UIs 200-1300) can be presented. The user interfaces can be configured to implement visual scripting based on a set of physics controller nodes. The set of physics controller nodes enable to refine physics simulations in a 3D environment. The set of physics controller nodes can include a ray cast node. The ray cast node can be used to project an invisible ray in the 3D environment to detect objects in the path of the invisible ray. The ray cast node can be useful for line-of-sight interactions and/or distance measurements. The set of physics controller nodes can further include a ray hit information node. The ray hit information node can be used to capture and relay information about objects hit by a ray cast, including distance and hit location.

At 2004, a ray can be projected. The ray can be projected using the ray cast node. Line-of-sight interactions and distance measurements associated with the projected ray in the 3D environment can be facilitated using the ray cast node. At 2006, information can be displayed. The information can include information about objects hit by the projected ray in the 3D environment. The information can be displayed using the ray hit information node.

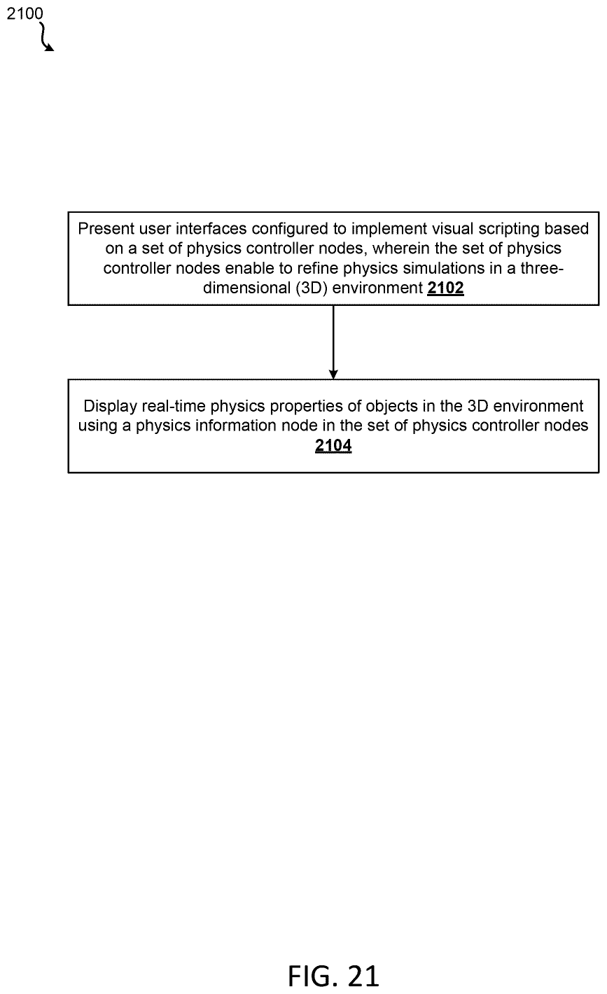

FIG. 21 illustrates an example process 2100 for creating physics-based content in accordance with the present disclosure. The process 2100 can be performed, for example, by the content creation service 118 and/or the application 106. Although depicted as a sequence of operations in FIG. 21, those of ordinary skill in the art will appreciate that various embodiments may add, remove, reorder, or modify the depicted operations.

At 2102, user interfaces (e.g., UIs 200-1300) can be presented. The user interfaces can be configured to implement visual scripting based on a set of physics controller nodes. The set of physics controller nodes enable to refine physics simulations in a 3D environment. The set of physics controller nodes can include a physics information node. The physics information node can be used to gathers and display real-time physics properties of objects, such as velocity and mass, aiding in debugging and development during the content creation process.

At 2104, real-time physics properties of objects in the 3D environment can be displayed. The real-time physics properties of objects in the 3D environment can be displayed using the physics information node. The real-time physics properties of objects in the 3D environment can include, for example, a speed, such as a scalar magnitude of the velocity, of the objects. The real-time physics properties of objects in the 3D environment can include a velocity, such as a speed and direction of movement, of the objects. The real-time physics properties of objects in the 3D environment can include an angular velocity, such as a rate and axis of rotation, of the object. The real-time physics properties of objects in the 3D environment can include a total force on the object, such as a sum of all forces acting on the body of the object. The real-time physics properties of objects in the 3D environment can include a total torque, such as a sum of all torques, on the object. The real-time physics properties of objects in the 3D environment can include a mass of the object. The real-time physics properties of objects in the 3D environment can include a damping of the object, such as the resistance of the object to linear motion. The real-time physics properties of objects in the 3D environment can include an angular damping of the object, such as a resistance of the object to rotational motion. The real-time physics properties of objects in the 3D environment can indicate if the object is static (e.g., immovable).

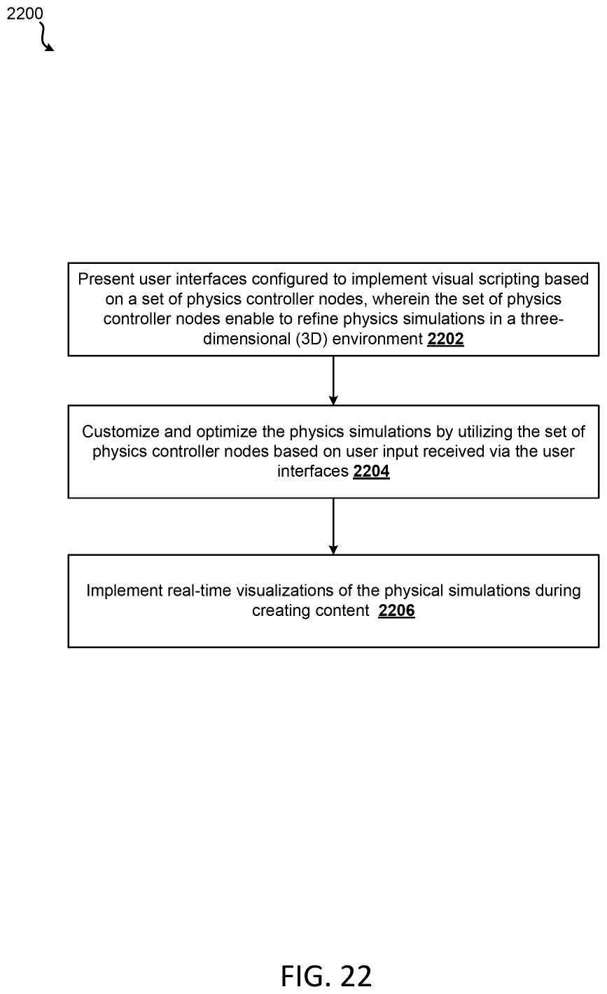

FIG. 22 illustrates an example process 2200 for creating physics-based content in accordance with the present disclosure. The process 2200 can be performed, for example, by the content creation service 118 and/or the application 106. Although depicted as a sequence of operations in FIG. 22, those of ordinary skill in the art will appreciate that various embodiments may add, remove, reorder, or modify the depicted operations.

At 2202, user interfaces (e.g., UIs 200-1300) can be presented. The user interfaces can be configured to implement visual scripting based on a set of physics controller nodes. The set of physics controller nodes enable to refine physics simulations in a 3D environment.

The set of physics controller nodes can be configured to refine physics simulations in a 3D environment. The set of physics controller nodes can include an acceleration controller node. The acceleration controller node may be used to manage the acceleration of objects, enabling dynamic changes in the speed and direction. The set of physics controller nodes can further include an impulse node. The impulse node can be used to apply instantaneous force to objects, simulating realistic impacts and movements. The set of physics controller nodes can further include a force controller node. The force controller node can be used to cause continuous application of force to objects, enabling sustained movements or interactions. The set of physics controller nodes can further include a velocity controller node. The velocity controller node can be used to directly control the velocity of objects, facilitating precise movements and behaviors. The set of physics controller nodes can further include a physics information node. The physics information node can be used to gathers and display real-time physics properties of objects, such as velocity and mass, aiding in debugging and development during the content creation process.

The set of physics controller nodes can further include a collision event node. The collision event node can be used to detect collisions between objects, triggering specific responses or behaviors. The set of physics controller nodes can further include a collision information node. The collision information node can be used to provides detailed information, such as real-time information, about collision events, including the objects involved in the collision and points of impact associated with the collision. The set of physics controller nodes can further include a ray cast node. The ray cast node can be used to project an invisible ray in the 3D environment to detect objects in the path of the invisible ray. The ray cast node can be useful for line-of-sight interactions and/or distance measurements. The set of physics controller nodes can further include a ray hit information node. The ray hit information node can be used to capture and relay information about objects hit by a ray cast, including distance and hit location.

At 2204, the physics simulations can be customized and optimized. The physics simulations can be customized and optimized by utilizing the set of physics controller nodes. The content creation service 118 and/or the application 106 can customize and optimize the physics simulations based on user input received via one or more of the user interfaces.

At 2206, real-time visualizations of the physical simulations can be implemented. The real-time visualizations of the physical simulations can be implemented during creating content. The real-time visualizations can be displayed via a preview window (e.g., preview window 212). The preview window can display in real time a current design/creation state of content (e.g., how the content would look if no more changes or modifications are made to the content). The preview window can display the 3D environment incorporated with real-time camera inputs. The content can include, for example, an AR effect or a game.

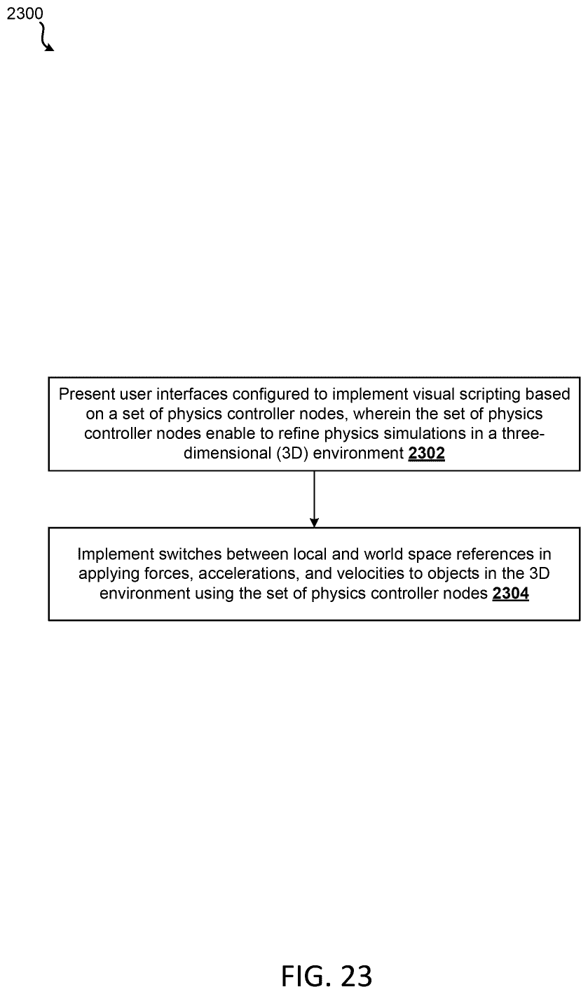

FIG. 23 illustrates an example process 2300 for creating physics-based content in accordance with the present disclosure. The process 2300 can be performed, for example, by the content creation service 118 and/or the application 106. Although depicted as a sequence of operations in FIG. 23, those of ordinary skill in the art will appreciate that various embodiments may add, remove, reorder, or modify the depicted operations.

At 2302, user interfaces (e.g., UIs 200-1300) can be presented. The user interfaces can be configured to implement visual scripting based on a set of physics controller nodes. The set of physics controller nodes enable to refine physics simulations in a 3D environment. The set of physics controller nodes can be configured to refine physics simulations in a 3D environment. The set of physics controller nodes can include an acceleration controller node. The acceleration controller node be used to manage the acceleration of objects, enabling dynamic changes in the speed and direction. The set of physics controller nodes can further include an impulse node. The impulse node can be used to apply instantaneous force to objects, simulating realistic impacts and movements. The set of physics controller nodes can further include a force controller node. The force controller node can be used to cause continuous application of force to objects, enabling sustained movements or interactions. The set of physics controller nodes can further include a velocity controller node. The velocity controller node can be used to directly control the velocity of objects, facilitating precise movements and behaviors.

At 2304, switches between local and world space references in applying forces, accelerations, and velocities to objects in the 3D environment can be implemented. In a world space, positions of objects/events (e.g., world space coordinates) can be determined in relation to a world view. In a local space, positions of objects/events (e.g., local space coordinates) can be determined in relation to a local object. The switches between local and world space references can be implemented using the set of physics controller nodes. For example, the user can specify whether the acceleration should be applied in a local space or a global (e.g., world) space using the acceleration controller node. The user can specify whether the velocity should be set in a local space or a global (e.g., world) space using the velocity controller node. The user can specify whether the continuous force should be set in a local space or a global (e.g., world) space using the force controller node. The user can specify whether the instantaneous force should be set in a local space or a global (e.g., world) space using the impulse node.

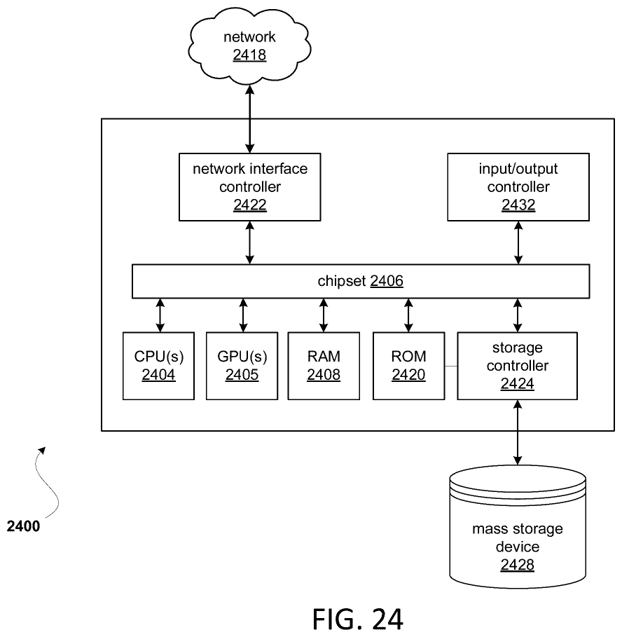

FIG. 24 illustrates a computing device that may be used in various aspects, such as the model(s), components, and/or devices depicted in FIG. 1. With regard to FIG. 1, any or all of the components may each be implemented by one or more instance of a computing device 2400 of FIG. 24. The computer architecture shown in FIG. 24 shows a conventional server computer, workstation, desktop computer, laptop, tablet, network appliance, PDA, e-reader, digital cellular phone, or other computing node, and may be utilized to execute any aspects of the computers described herein, such as to implement the methods described herein.

The computing device 2400 may include a baseboard, or “motherboard,” which is a printed circuit board to which a multitude of components or devices may be connected by way of a system bus or other electrical communication paths. One or more central processing units (CPUs) 2404 may operate in conjunction with a chipset 2406. The CPU(s) 2404 may be standard programmable processors that perform arithmetic and logical operations necessary for the operation of the computing device 2400.

The CPU(s) 2404 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 2404 may be augmented with or replaced by other processing units, such as GPU(s) 2405. The GPU(s) 2405 may comprise processing units specialized for but not necessarily limited to highly parallel computations, such as graphics and other visualization-related processing.

A chipset 2406 may provide an interface between the CPU(s) 2404 and the remainder of the components and devices on the baseboard. The chipset 2406 may provide an interface to a random-access memory (RAM) 2408 used as the main memory in the computing device 2400. The chipset 2406 may further provide an interface to a computer-readable storage medium, such as a read-only memory (ROM) 2420 or non-volatile RAM (NVRAM) (not shown), for storing basic routines that may help to start up the computing device 2400 and to transfer information between the various components and devices. ROM 2420 or NVRAM may also store other software components necessary for the operation of the computing device 2400 in accordance with the aspects described herein.

The computing device 2400 may operate in a networked environment using logical connections to remote computing nodes and computer systems through local area network (LAN). The chipset 2406 may include functionality for providing network connectivity through a network interface controller (NIC) 2422, such as a gigabit Ethernet adapter. A NIC 2422 may be capable of connecting the computing device 2400 to other computing nodes over a network 2418. It should be appreciated that multiple NICs 2422 may be present in the computing device 2400, connecting the computing device to other types of networks and remote computer systems.

The computing device 2400 may be connected to a mass storage device 2428 that provides non-volatile storage for the computer. The mass storage device 2428 may store system programs, application programs, other program modules, and data, which have been described in greater detail herein. The mass storage device 2428 may be connected to the computing device 2400 through a storage controller 2424 connected to the chipset 2406. The mass storage device 2428 may consist of one or more physical storage units. The mass storage device 2428 may comprise a management component 2410. A storage controller 2424 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 2400 may store data on the mass storage device 2428 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 2428 is characterized as primary or secondary storage and the like.

For example, the computing device 2400 may store information to the mass storage device 2428 by issuing instructions through a storage controller 2424 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 2400 may further read information from the mass storage device 2428 by detecting the physical states or characteristics of one or more particular locations within the physical storage units.

In addition to the mass storage device 2428 described above, the computing device 2400 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 2400.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 2428 depicted in FIG. 24, may store an operating system utilized to control the operation of the computing device 2400. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 2428 may store other system or application programs and data utilized by the computing device 2400.

The mass storage device 2428 or other computer-readable storage media may also be encoded with computer-executable instructions, which, when loaded into the computing device 2400, transforms the computing device from a general-purpose computing system into a special-purpose computer capable of implementing the aspects described herein. These computer-executable instructions transform the computing device 2400 by specifying how the CPU(s) 2404 transition between states, as described above. The computing device 2400 may have access to computer-readable storage media storing computer-executable instructions, which, when executed by the computing device 2400, may perform the methods described herein, such as the methods shown in FIGS. 11-24.

A computing device, such as the computing device 2400 depicted in FIG. 24, may also include an input/output controller 2432 for receiving and processing input from a number of input devices, such as a keyboard, a mouse, a touchpad, a touch screen, an electronic stylus, or other type of input device. Similarly, an input/output controller 2432 may provide output to a display, such as a computer monitor, a flat-panel display, a digital projector, a printer, a plotter, or other type of output device. It will be appreciated that the computing device 2400 may not include all of the components shown in FIG. 24, may include other components that are not explicitly shown in FIG. 24, or may utilize an architecture completely different than that shown in FIG. 24.

As described herein, a computing device may be a physical computing device, such as the computing device 2400 of FIG. 24. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

The present methods and systems may be understood more readily by reference to the following detailed description of preferred embodiments and the examples included therein and to the Figures and their descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses, and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method of creating physics-based content, comprising:
establishing a set of physics controller nodes, wherein the set of physics controller nodes are configured to refine physics simulations in a three-dimensional (3D) environment;
presenting user interfaces configured to implement visual scripting based on the set of physics controller nodes;
customizing the physics simulations by utilizing the set of physics controller nodes based on user input received via the user interfaces; and
creating content based on the customized and optimized physics simulations.

2. The method of claim 1, further comprising:
implementing dynamic changes in a speed and direction of an object in the 3D environment and managing an acceleration of the object using an acceleration controller node in the set of physics controller nodes.

3. The method of claim 1, further comprising:
simulating realistic impacts and movements by applying instantaneous forces to an object in the 3D environment using an impulse node in the set of physics controller nodes.

4. The method of claim 1, further comprising:
implementing sustained movements or interactions by applying continuous forces to objects in the 3D environment using a force controller node in the set of physics controller nodes.

5. The method of claim 1, further comprising:
implementing movements and behaviors by directly controlling a velocity of an object in the 3D environment using a velocity controller node in the set of physics controller nodes.

6. The method of claim 1, further comprising:
detecting collisions between objects and triggering particular responses in the 3D environment using a collision event node in the set of physics controller nodes.

7. The method of claim 1, further comprising:
projecting a ray and facilitating line-of-sight interactions and distance measurements in the 3D environment using a ray cast node in the set of physics controller nodes.

8. The method of claim 1, further comprising:
displaying real-time physics properties of objects in the 3D environment using a physics information node in the set of physics controller nodes;
displaying information about collision events in the 3D environment using a collision information node in the set of physics controller nodes; or
displaying information about objects hit by a ray in the 3D environment using a ray hit information node in the set of physics controller nodes.

9. The method of claim 1, further comprising:
implementing switches between local and world space references in applying forces, accelerations, and velocities to objects in the 3D environment using the set of physics controller nodes.

10. The method of claim 1, further comprising:
implementing real-time visualizations of the physical simulations during creating the content.

11. A system of creating physics-based content, comprising:
at least one processor; and
at least one memory communicatively coupled to the at least one processor and comprising computer-readable instructions that upon execution by the at least one processor cause the at least one processor to perform operations comprising:
establishing a set of physics controller nodes, wherein the set of physics controller nodes are configured to refine physics simulations in a three-dimensional (3D) environment;
presenting user interfaces configured to implement visual scripting based on the set of physics controller nodes;
customizing the physics simulations by utilizing the set of physics controller nodes based on user input received via the user interfaces; and
creating content based on the customized and optimized physics simulations.

12. The system of claim 11, the operations further comprising:
implementing dynamic changes in a speed and direction of an object in the 3D environment and managing an acceleration of the object using an acceleration controller node in the set of physics controller nodes.

13. The system of claim 11, the operations further comprising:
simulating realistic impacts and movements by applying instantaneous forces to an object in the 3D environment using an impulse node in the set of physics controller nodes.

14. The system of claim 11, the operations further comprising:
implementing sustained movements or interactions by applying continuous forces to objects in the 3D environment using a force controller node in the set of physics controller nodes.

15. The system of claim 11, the operations further comprising:
projecting a ray and facilitating line-of-sight interactions and distance measurements in the 3D environment using a ray cast node in the set of physics controller nodes.

16. A non-transitory computer-readable storage medium, storing computer-readable instructions that upon execution by a processor cause the processor to implement operations comprising:
establishing a set of physics controller nodes, wherein the set of physics controller nodes are configured to refine physics simulations in a three-dimensional (3D) environment;
presenting user interfaces configured to implement visual scripting based on the set of physics controller nodes;
customizing the physics simulations by utilizing the set of physics controller nodes based on user input received via the user interfaces; and
creating content based on the customized and optimized physics simulations.

17. The non-transitory computer-readable storage medium of claim 16, the operations further comprising:
implementing dynamic changes in a speed and direction of an object in the 3D environment and managing an acceleration of the object using an acceleration controller node in the set of physics controller nodes.

18. The non-transitory computer-readable storage medium of claim 16, the operations further comprising:
simulating realistic impacts and movements by applying instantaneous forces to an object in the 3D environment using an impulse node in the set of physics controller nodes.

19. The non-transitory computer-readable storage medium of claim 16, the operations further comprising:
implementing sustained movements or interactions by applying continuous forces to objects in the 3D environment using a force controller node in the set of physics controller nodes.

20. The non-transitory computer-readable storage medium of claim 16, the operations further comprising:
projecting a ray and facilitating line-of-sight interactions and distance measurements in the 3D environment using a ray cast node in the set of physics controller nodes.
